(19) United States
(12) Patent Application Publication
(10) Pub. No.: US 2011/0145739 A1
(43) Pub. Date: Jun. 16, 2011

(54) Device, Method, and Graphical User Interface for Location-Based Data Collection

(76) Inventors: Peter Glen Berger, Irwin, PA (US); Yik Shing Yip, Sunnyvale, CA (US); Matthew Ross Lehrian, Pittsburgh, PA (US); Michael Jeremy Coblenz, Sunnyvale, CA (US)

(21) Appl. No.: 12/639,671

(22) Filed: Dec. 16, 2009

(51) Int. Cl. G06F 3/048

(52) U.S. Cl. 715/763

(57) ABSTRACT

Automated population of location-based data and formulae into electronic documents is disclosed. In one embodiment, in response to detecting a user selection of a first data population control, first location-based data is populated in an electronic document, wherein the first location-based data includes data obtained from a location-data source. After the first location-based data is populated in the electronic document, in response to detecting a user selection of a second data population control, second location-based data and one or more formulae are populated in the electronic document, wherein the second location-based data includes data obtained from the location-data source, and wherein the one or more formulae are configured for performing calculations upon the first and second location-based data.

### TECHNICAL FIELD

The disclosed embodiments relate generally to electronic computing devices, and more particularly, to computing devices that perform automated population of location-based data, sensor-generated data, and formulae in electronic documents.

### BACKGROUND

The use of computers and other electronic computing devices to receive location-based data has increased significantly in recent years. Exemplary computing devices that include capabilities of determining and/or receiving location-based data include mobile telephones, laptop and tablet computers, electronic book readers, consumer electronics, personal digital assistants, etc.

Many users rely on electronic computing devices for determining and/or receiving location-based data and sensor-generated data, as well as placing that data into electronic documents. Unfortunately, existing methods for populating and recording location-based data and sensor-generated data in electronic documents are cumbersome and inefficient. In addition, existing methods take longer than necessary, thereby wasting energy. This latter consideration is particularly important in battery-operated devices.

Accordingly, there is a need for computing devices with faster, more efficient methods and interfaces for performing automated population of location-based data, sensor-generated data, and formulae in electronic documents. Such methods and interfaces may complement or replace conventional methods for population of location-based and sensor-generated data. Such methods and interfaces reduce the cognitive burden on a user and produce a more efficient human-machine interface. For battery-operated computing devices, such methods and interfaces conserve power and increase the time between battery charges.

### SUMMARY

The above deficiencies and other problems associated with user interfaces for electronic computing devices are reduced or eliminated by the disclosed devices. In some embodiments, the device is a desktop computer. In some embodiments, the device is portable (e.g., a notebook computer, tablet computer, or handheld device). In some embodiments, the device has a touchpad. In some embodiments, the device has a touch-sensitive display (also known as a “touch screen” or “touch screen display”). In some embodiments, the device has a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive surface. In some embodiments, the functions may include image editing, drawing, presenting, word processing, website creating, disk authoring, spreadsheet making, game playing, telephoning, video conferencing, e-mailing, instant messaging, workout support, digital photographing, digital video recording, web browsing, digital music playing, and/or digital video playing. Executable instructions for performing these functions may be included in a computer readable storage medium or other computer program product configured for execution by one or more processors.

In accordance with some embodiments, a method is performed while displaying an electronic document at a computing device with a display and one or more user input devices. The method includes: detecting activation of a first data population control; in response to detecting activation of the first data population control, populating in the electronic document first location-based data that includes data obtained from a location-data source; after the first location-based data is populated in the electronic document, detecting activation of a second data population control; in response to detecting activation of the second data population control, populating in the electronic document one or more formulae and second location-based data, wherein: the one or more formulae are adapted for performing one or more calculations using the first and second location-based data, and, the second location-based data includes data obtained from the location-data source; calculating one or more location-based metrics using the one or more formulae with at least one of the first and second location-based data; and displaying in the electronic document the one or more calculated location-based metrics.

In accordance with some embodiments, a computing device includes a display, one or more user input devices, one or more processors, memory, and one or more programs. The one or more programs are stored in the memory and configured to be executed by the one or more processors. The one or more programs include instructions for: while displaying an electronic document on the display at the computing device: detecting activation of a first data population control; in response to detecting activation of the first data population control, populating in the electronic document first location-based data that includes data obtained from a location-data source; after the first location-based data is populated in the electronic document, detecting activation of a second data population control; in response to detecting activation of the second data population control, populating in the electronic document one or more formulae and second location-based data, wherein: the one or more formulae are adapted for performing one or more calculations using the first and second location-based data, and, the second location-based data includes data obtained from the location-data source; calculating one or more location-based metrics using the one or more formulae with at least one of the first and second location-based data; and, displaying in the electronic document the one or more calculated location-based metrics.

In accordance with some embodiments there is a graphical user interface on a computing device with a display, one or more user input devices, a memory, and one or more processors to execute one or more programs stored in the memory. The graphical user interface includes an electronic document, a first data population control, and a second data population control, wherein the electronic document is displayed on the display of the computing device, and wherein the graphical user interface is configured such that: activation of a first data population control is detected; in response to detecting activation of the first data population control, first location-based data, which includes data obtained from a location-data source, is populated in the electronic document; after the first location-based data is populated in the electronic document, activation of a second data population control is detected; in response to detecting activation of the second data population control, one or more formulae and second location-based data is populated in the electronic document, wherein: the one or more formulae are adapted for performing one or more calculations using the first and second location-based data, and, the second location-based data includes data obtained from the location-data source; one or more location-based metrics are calculated using the one or more formulae with at least one of the first and second location-based data; and, the one or more calculated location-based metrics are displayed in the electronic document.

In accordance with some embodiments, a computer readable storage medium has stored therein one or more programs, the one or more programs comprising instructions, which when executed by a computing device with a display and one or more user input devices, cause the computing device to: while displaying an electronic document on the display: detect activation of a first data population control; in response to detecting activation of the first data population control, populate in the electronic document first location-based data that includes data obtained from a location-data source; after the first location-based data is populated in the electronic document, detect activation of a second data population control; in response to detecting activation of the second data population control, populate in the electronic document one or more formulae and second location-based data, wherein: the one or more formulae are adapted for performing one or more calculations using the first and second location-based data, and, the second location-based data includes data obtained from the location-data source; calculate one or more location-based metrics using the one or more formulae with at least one of the first and second location-based data; and display in the electronic document the one or more calculated location-based metrics.

In accordance with some embodiments, a computing device includes a display; one or more user input devices; and means for displaying an electronic document on the display at the computing device, and while displaying the electronic document on the display at the computing device: means for detecting activation of a first data population control; in response to detecting activation of the first data population control, means for populating in the electronic document first location-based data that includes data obtained from a location-data source; after the first location-based data is populated in the electronic document, means for detecting activation of a second data population control; in response to detecting activation of the second data population control, means for populating in the electronic document one or more formulae and second location-based data, wherein: the one or more formulae are adapted for performing one or more calculations using the first and second location-based data, and, the second location-based data includes data obtained from the location-data source; means for calculating one or more location-based metrics using the one or more formulae with at least one of the first and second location-based data; and, means for displaying in the electronic document the one or more calculated location-based metrics.

In accordance with some embodiments, an information processing apparatus for use in a computing device includes a display, one or more user input devices, and means for displaying an electronic document on the display at the computing device, and while displaying the electronic document on the display at the computing device: means for detecting activation of a first data population control; in response to detecting activation of the first data population control, means for populating in the electronic document first location-based data that includes data obtained from a location-data source; after the first location-based data is populated in the electronic document, means for detecting activation of a second data population control; in response to detecting activation of the second data population control, means for populating in the electronic document one or more formulae and second location-based data, wherein: the one or more formulae are adapted for performing one or more calculations using the first and second location-based data, and, the second location-based data includes data obtained from the location-data source; means for calculating one or more location-based metrics using the one or more formulae with at least one of the first and second location-based data; and, means for displaying in the electronic document the one or more calculated location-based metrics.

In accordance with some embodiments, a method is performed at a computing device with a display and one or more user input devices adapted to detect user gestures. The method includes, while displaying an electronic document, populating in the electronic document one or more formulae and first location-based data that includes data obtained from a location-data source, wherein the one or more formulae are adapted for performing one or more calculations using location-based data, and the first location-based data corresponds to a first physical location; calculating one or more location-based metrics using the one or more formulae with at least the first location-based data; and displaying in the electronic document the one or more calculated location-based metrics.

In accordance with some embodiments, a computing device includes a display, one or more user input devices adapted to detect user gestures, one or more processors, memory, and one or more programs. The one or more programs are stored in the memory and configured to be executed by the one or more processors. The one or more programs include instructions for: while displaying an electronic document, populating in the electronic document one or more formulae and first location-based data that includes data obtained from a location-data source, wherein the one or more formulae are adapted for performing one or more calculations using location-based data, and the first location-based data corresponds to a first physical location; calculating one or more location-based metrics using the one or more formulae with at least the first location-based data; and displaying in the electronic document the one or more calculated location-based metrics.

In accordance with some embodiments, a computer readable storage medium has stored therein one or more programs, the one or more programs comprising instructions, which when executed by a computing device with a display and one or more user input devices adapted to detect user gestures, cause the computing device to: while displaying an electronic document, populate in the electronic document one or more formulae and first location-based data that includes data obtained from a location-data source, wherein the one or more formulae are adapted for performing one or more calculations using location-based data, and the first location-based data corresponds to a first physical location; calculate one or more location-based metrics using the one or more formulae with at least the first location-based data; and display in the electronic document the one or more calculated location-based metrics.

In accordance with some embodiments, a computing device includes a display; one or more user input devices adapted to detect user gestures; and while displaying an electronic document, means for populating in the electronic document one or more formulae and first location-based data that includes data obtained from a location-data source, wherein the one or more formulae are adapted for performing one or more calculations using location-based data, and the first location-based data corresponds to a first physical location; means for calculating one or more location-based metrics using the one or more formulae with at least the first location-based data; and means for displaying in the electronic document the one or more calculated location-based metrics.

In accordance with some embodiments, an information processing apparatus for use in a computing device includes a display, one or more user input devices adapted to detect user gestures, and while displaying an electronic document, means for populating in the electronic document one or more formulae and first location-based data that includes data obtained from a location-data source, wherein the one or more formulae are adapted for performing one or more calculations using location-based data, and the first location-based data corresponds to a first physical location; means for calculating one or more location-based metrics using the one or more formulae with at least the first location-based data; and means for displaying in the electronic document the one or more calculated location-based metrics.

In accordance with some embodiments, a method is performed at a computing device with a display and one or more user input devices adapted to detect user gestures. The method includes while displaying an electronic document, populating in the electronic document one or more formulae and first sensor-generated data that includes data obtained from a sensor, wherein the one or more formulae are adapted for performing one or more calculations using sensor-generated data, and wherein the sensor is selected from the group consisting of an accelerometer, a proximity sensor, a magnetometer, an optical sensor, a microphone, a thermometer, a thermocouple, a hygrometer, a voltmeter, an ammeter, an ohmmeter, a seismometer, a microphone, and a speedometer. The method also includes calculating one or more metrics using the one or more formulae with at least the first sensor-generated data; and displaying in the electronic document the one or more calculated metrics; updating at least the first sensor-generated data with current sensor-generated data obtained from the sensor; recalculating the one or more metrics using the one or more formulae with at least the current sensor-generated data; and displaying in the electronic document the one or more recalculated metrics.

In accordance with some embodiments, a computing device includes a display, one or more user input devices adapted to detect user gestures, one or more processors, memory, and one or more programs. The one or more programs are stored in the memory and configured to be executed by the one or more processors. The one or more programs include instructions for: while displaying an electronic document, populating in the electronic document one or more formulae and first sensor-generated data that includes data obtained from a sensor, wherein the one or more formulae are adapted for performing one or more calculations using sensor-generated data, and wherein the sensor is selected from the group consisting of an accelerometer, a proximity sensor, a magnetometer, an optical sensor, a microphone, a thermometer, a thermocouple, a hygrometer, a voltmeter, an ammeter, an ohmmeter, a seismometer, a microphone, and a speedometer. The one or more programs also include instructions for calculating one or more metrics using the one or more formulae with at least the first sensor-generated data; and displaying in the electronic document the one or more calculated metrics.

In accordance with some embodiments, a computer readable storage medium has stored therein one or more programs, the one or more programs comprising instructions, which when executed by a computing device with a display and one or more user input devices adapted to detect user gestures, cause the computing device to: while displaying an electronic document, populate in the electronic document one or more formulae and first sensor-generated data that includes data obtained from a sensor, wherein the one or more formulae are adapted for performing one or more calculations using sensor-generated data, and wherein the sensor is selected from the group consisting of an accelerometer, a proximity sensor, a magnetometer, an optical sensor, a microphone, a thermometer, a thermocouple, a hygrometer, a voltmeter, an ammeter, an ohmmeter, a seismometer, a microphone, and a speedometer. The one or more programs also comprise instructions which cause the computing device to calculate one or more metrics using the one or more formulae with at least the first sensor-generated data, and to display in the electronic document the one or more calculated metrics.

In accordance with some embodiments, a computing device includes a display; one or more user input devices adapted to detect user gestures; and while displaying an electronic document, means for populating in the electronic document one or more formulae and first sensor-generated data that includes data obtained from a sensor, wherein the one or more formulae are adapted for performing one or more calculations using sensor-generated data, and wherein the sensor is selected from the group consisting of an accelerometer, a proximity sensor, a magnetometer, an optical sensor, a microphone, a thermometer, a thermocouple, a hygrometer, a voltmeter, an ammeter, an ohmmeter, a seismometer, a microphone, and a speedometer. The computing device also includes means for calculating one or more metrics using the one or more formulae with at least the first sensor-generated data; and means for displaying in the electronic document the one or more calculated metrics.

In accordance with some embodiments, an information processing apparatus for use in a computing device includes a display, one or more user input devices adapted to detect user gestures, and while displaying an electronic document, means for populating in the electronic document one or more formulae and first sensor-generated data that includes data obtained from a sensor, wherein the one or more formulae are adapted for performing one or more calculations using sensor-generated data, and wherein the sensor is selected from the group consisting of an accelerometer, a proximity sensor, a magnetometer, an optical sensor, a microphone, a thermometer, a thermocouple, a hygrometer, a voltmeter, an ammeter, an ohmmeter, a seismometer, a microphone, and a speedometer. The information processing apparatus also includes means for calculating one or more metrics using the one or more formulae with at least the first sensor-generated data; and means for displaying in the electronic document the one or more calculated metrics.

Thus, computing devices with are provided with faster, more efficient methods and interfaces for performing automated population of location-based data, sensor-generated data, and formulae in electronic documents, thereby increasing the effectiveness, efficiency, and user satisfaction with such devices. Such methods and interfaces may complement and/or replace conventional methods for population of location-based data, sensor-generated data, and formulae in electronic documents.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIGS. 1A and 1B are block diagrams illustrating portable multifunction devices with touch-sensitive displays in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIGS. 4A and 4B illustrate exemplary user interfaces for a menu of applications on a portable multifunction device in accordance with some embodiments.

FIG. 4C illustrates an exemplary user interface for a multifunction device with a touch-sensitive surface that is separate from the display in accordance with some embodiments.

FIGS. 5A-5M illustrate exemplary user interfaces for automated population of location-based data and formulae in electronic documents in accordance with some embodiments.

FIGS. 6A-6C are flow diagrams illustrating a method of automated population of location-based data and formulae in electronic documents in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of computing devices, user interfaces for such devices, and associated processes for using such devices are described. In some embodiments, the computing device is a portable communications device such as a mobile telephone that also contains other functions, such as PDA and/or music player functions. Exemplary embodiments of portable multifunction devices include, without limitation, the iPhone® and iPod Touch® devices from Apple, Inc. of Cupertino, Calif. Other portable devices such as laptops or tablet computers with touch-sensitive surfaces (e.g., touch screen displays and/or touch pads) may also be used. It should also be understood that, in some embodiments, the device is not a portable communications device, but is a desktop computer with a touch-sensitive surface (e.g., a touch screen display and/or a touch pad).

In the discussion that follows, a computing device that includes a display and a touch-sensitive surface is described. In some embodiments, the computing device described includes a touch-screen display. It should be understood, however, that the computing device may include one or more other physical user-interface devices, such as a physical keyboard, a mouse and/or a joystick.

The device supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that may be executed on the device may use at least one common physical user-interface device, such as the touch-sensitive surface. One or more functions of the touch-sensitive surface as well as corresponding information displayed on the device may be adjusted and/or varied from one application to the next and/or within a respective application. In this way, a common physical architecture (such as the touch-sensitive surface) of the device may support the variety of applications with user interfaces that are intuitive and transparent.

The user interfaces may include one or more soft keyboard embodiments. The soft keyboard embodiments may include standard (QWERTY) and/or non-standard configurations of symbols on the displayed icons of the keyboard, such as those described in U.S. patent application Ser. Nos. 11/459,606, “Keyboards For Portable Electronic Devices,” filed Jul. 24, 2006, and 11/459,615, “Touch Screen Keyboards For Portable Electronic Devices,” filed Jul. 24, 2006, the contents of which are hereby incorporated by reference in their entirety. The keyboard embodiments may include a reduced number of icons (or soft keys) relative to the number of keys in existing physical keyboards, such as that for a typewriter. This may make it easier for users to select one or more icons in the keyboard, and thus, one or more corresponding symbols. The keyboard embodiments may be adaptive. For example, displayed icons may be modified in accordance with user actions, such as selecting one or more icons and/or one or more corresponding symbols. One or more applications on the device may utilize common and/or different keyboard embodiments. Thus, the keyboard embodiment used may be tailored to at least some of the applications. In some embodiments, one or more keyboard embodiments may be tailored to a respective user. For example, one or more keyboard embodiments may be tailored to a respective user based on a word usage history (lexicography, slang, individual usage) of the respective user. Some of the keyboard embodiments may be adjusted to reduce a probability of a user error when selecting one or more icons, and thus one or more symbols, when using the soft keyboard embodiments.

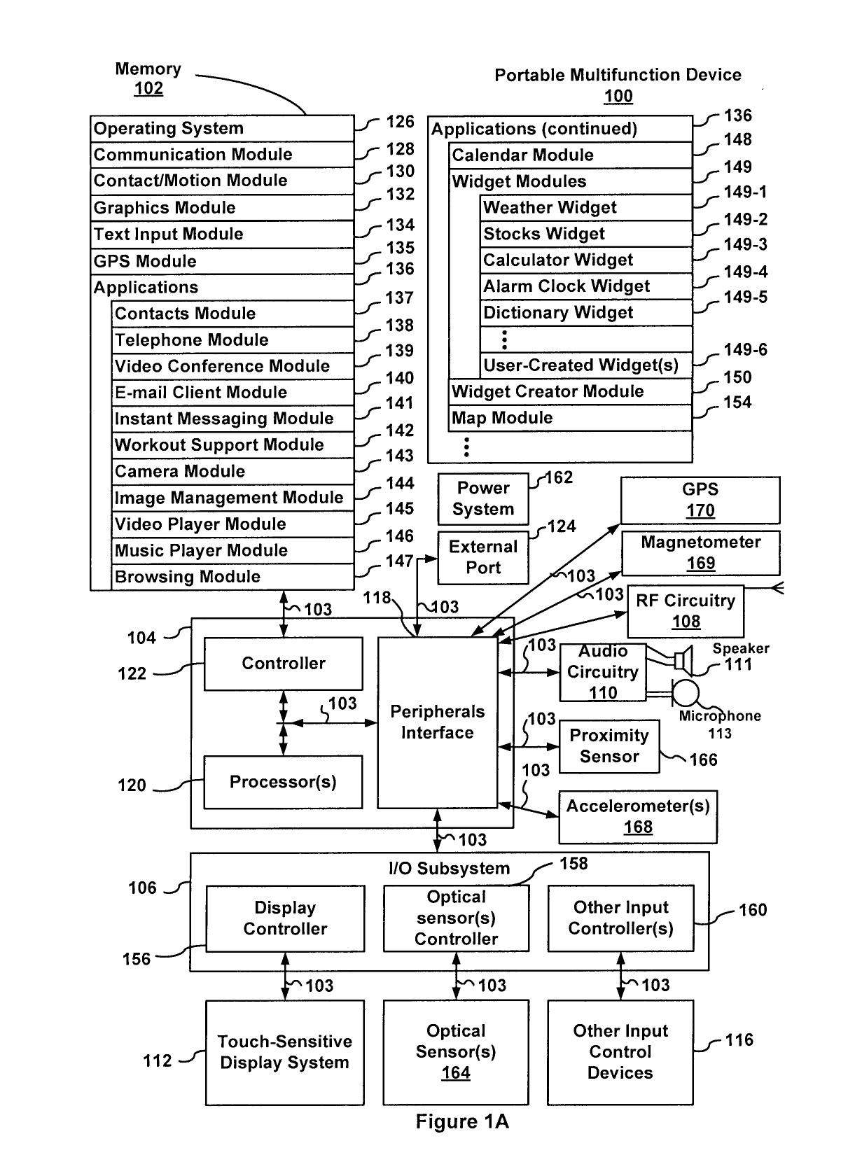

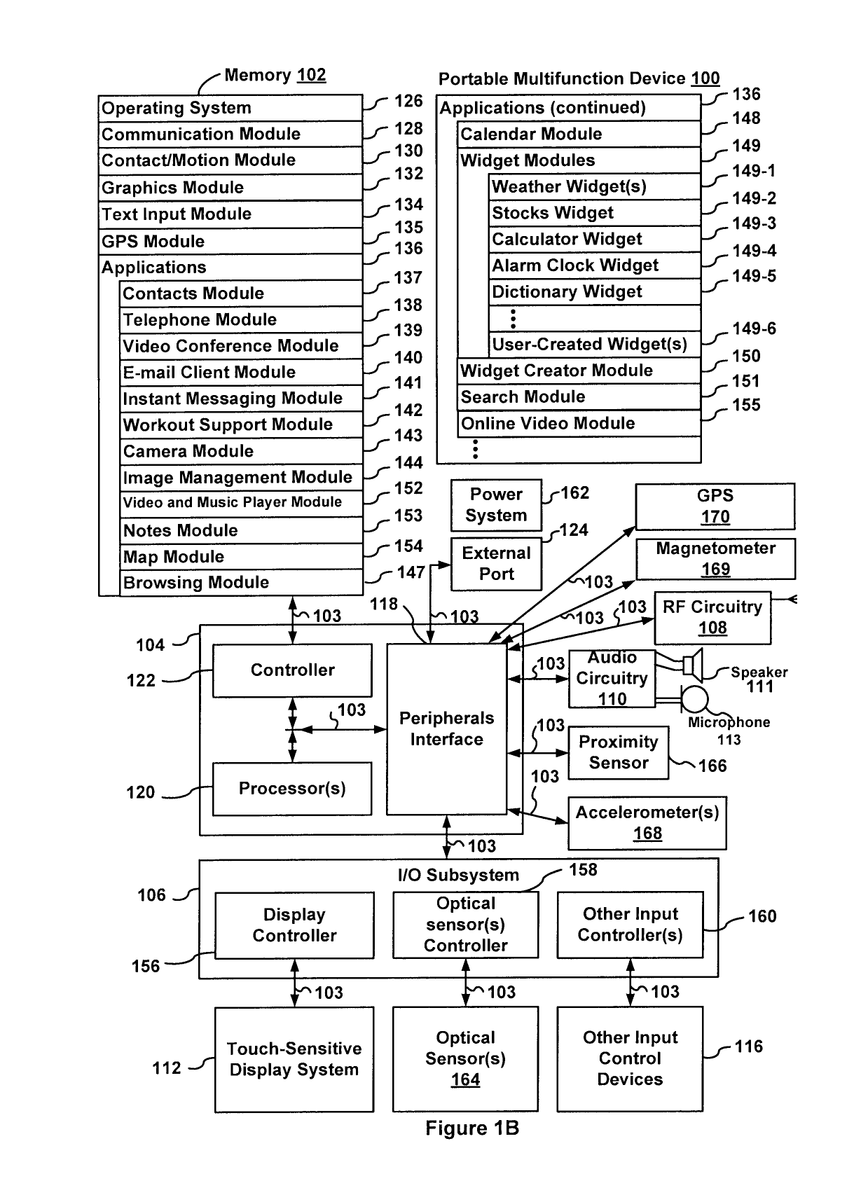

Attention is now directed towards embodiments of portable devices with touch-sensitive displays. FIGS. 1A and 1B are block diagrams illustrating portable multifunction devices 100 with touch-sensitive displays 112 in accordance with some embodiments. The touch-sensitive display 112 is sometimes called a “touch screen” for convenience, and may also be known as or called a touch-sensitive display system. The device 100 may include a memory 102 (which may include one or more computer readable storage mediums), a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. The device 100 may include one or more optical sensors 164. These components may communicate over one or more communication buses or signal lines 103.

It should be appreciated that the device 100 is only one example of a portable multifunction device 100, and that the device 100 may have more or fewer components than shown, may combine two or more components, or a may have a different configuration or arrangement of the components. The various components shown in FIGS. 1A and 1B may be implemented in hardware, software, or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for the device 100 and to process data.

In some embodiments, the peripherals interface 118, the CPU 120, and the memory controller 122 may be implemented on a single chip, such as a chip 104. In some other embodiments, they may be implemented on separate chips.

The RF (radio frequency) circuitry 108 receives and sends RF signals, also called electromagnetic signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

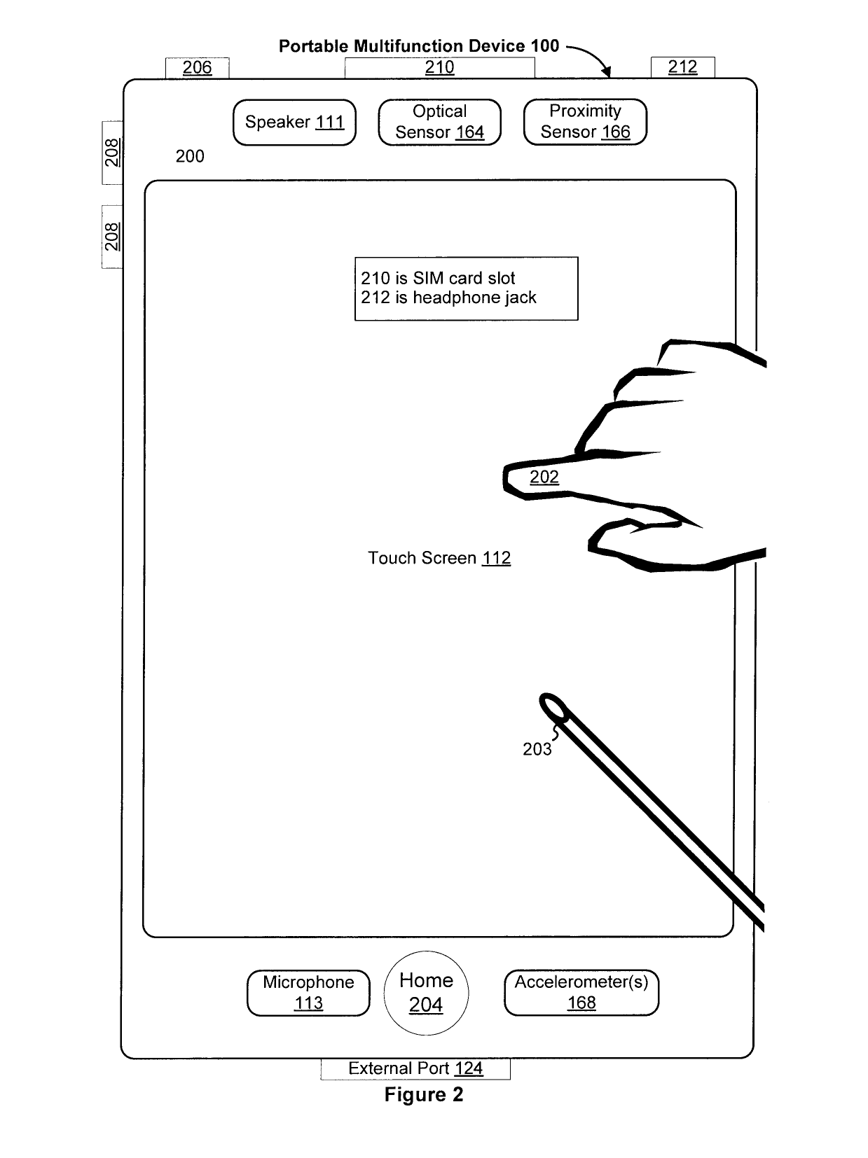

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. In some embodiments, the audio circuitry 110 also includes a headset jack (e.g. 212, FIG. 2). The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (e.g., 208, FIG. 2) may include an up/down button for volume control of the speaker 111 and/or the microphone 113. The one or more buttons may include a push button (e.g., 206, FIG. 2). A quick press of the push button may disengage a lock of the touch screen 112 or begin a process that uses gestures on the touch screen to unlock the device, as described in U.S. patent application Ser. No. 11/322,549, “Unlocking a Device by Performing Gestures on an Unlock Image,” filed Dec. 23, 2005, which is hereby incorporated by reference in its entirety. A longer press of the push button (e.g., 206) may turn power to the device 100 on or off. The user may be able to customize a functionality of one or more of the buttons. The touch screen 112 is used to implement virtual or soft buttons and one or more soft keyboards.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”). In some embodiments, some or all of the visual output may correspond to user-interface objects.

A touch screen 112 has a touch-sensitive surface, sensor or set of sensors that accepts input from the user based on haptic and/or tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. In an exemplary embodiment, a point of contact between a touch screen 112 and the user corresponds to a finger of the user.

The touch screen 112 may use LCD (liquid crystal display) technology, or LPD (light emitting polymer display) technology, although other display technologies may be used in other embodiments. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112. In an exemplary embodiment, projected mutual capacitance sensing technology is used, such as that found in the iPhone® and iPod Touch® from Apple, Inc. of Cupertino, Calif.

A touch-sensitive display in some embodiments of the touch screen 112 may be analogous to the multi-touch sensitive touchpads described in the following U.S. Pat. Nos. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, a touch screen 112 displays visual output from the portable device 100, whereas touch sensitive touchpads do not provide visual output.

A touch-sensitive display in some embodiments of the touch screen 112 may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

The touch screen 112 may have a resolution in excess of 100 dpi. In an exemplary embodiment, the touch screen has a resolution of approximately 160 dpi. The user may make contact with the touch screen 112 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, the device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 112 or an extension of the touch-sensitive surface formed by the touch screen.

In some embodiments, the device 100 may include a physical or virtual click wheel as an input control device 116. A user may navigate among and interact with one or more graphical objects (e.g., icons) displayed in the touch screen 112 by rotating the click wheel or by moving a point of contact with the click wheel (e.g., where the amount of movement of the point of contact is measured by its angular displacement with respect to a center point of the click wheel). The click wheel may also be used to select one or more of the displayed icons. For example, the user may press down on at least a portion of the click wheel or an associated button. User commands and navigation commands provided by the user via the click wheel may be processed by an input controller 160 as well as one or more of the modules and/or sets of instructions in memory 102. For a virtual click wheel, the click wheel and click wheel controller may be part of the touch screen 112 and the display controller 156, respectively. For a virtual click wheel, the click wheel may be either an opaque or semitransparent object that appears and disappears on the touch screen display in response to user interaction with the device. In some embodiments, a virtual click wheel is displayed on the touch screen of a portable multifunction device and operated by user contact with the touch screen.

The device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The device 100 may also include one or more optical sensors 164. FIGS. 1A and 1B show an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lenses, and converts the light to data representing an image. In conjunction with an imaging module 143 (also called a camera module), the optical sensor 164 may capture still images or video. In some embodiments, an optical sensor is located on the back of the device 100, opposite the touch screen display 112 on the front of the device, so that the touch screen display may be used as a viewfinder for still and/or video image acquisition. In some embodiments, an optical sensor is located on the front of the device so that the user's image may be obtained for videoconferencing while the user views the other video conference participants on the touch screen display. In some embodiments, the position of the optical sensor 164 can be changed by the user (e.g., by rotating the lens and the sensor in the device housing) so that a single optical sensor 164 may be used along with the touch screen display for both video conferencing and still and/or video image acquisition.

The device 100 may also include one or more proximity sensors 166. FIGS. 1A and 1B show a proximity sensor 166 coupled to the peripherals interface 118. Alternately, the proximity sensor 166 may be coupled to an input controller 160 in the I/O subsystem 106. The proximity sensor 166 may perform as described in U.S. patent application Ser. Nos. 11/241,839, “Proximity Detector In Handheld Device”; 11/240,788, “Proximity Detector In Handheld Device”; 11/620,702, “Using Ambient Light Sensor To Augment Proximity Sensor Output”; 11/586,862, “Automated Response To And Sensing Of User Activity In Portable Devices”; and 11/638,251, “Methods And Systems For Automatic Configuration Of Peripherals,” which are hereby incorporated by reference in their entirety. In some embodiments, the proximity sensor turns off and disables the touch screen 112 when the multifunction device is placed near the user's ear (e.g., when the user is making a phone call).

The device 100 may also include one or more accelerometers 168. FIGS. 1A and 1B show an accelerometer 168 coupled to the peripherals interface 118. Alternately, the accelerometer 168 may be coupled to an input controller 160 in the I/O subsystem 106. The accelerometer 168 may perform as described in U.S. Patent Publication No. 2005/0190059, “Acceleration-based Theft Detection System for Portable Electronic Devices,” and U.S. Patent Publication No. 2006/0017692, “Methods And Apparatuses For Operating A Portable Device Based On An Accelerometer,” both of which are which are incorporated by reference herein in their entirety. In some embodiments, information is displayed on the touch screen display in a portrait view or a landscape view based on an analysis of data received from the one or more accelerometers.

The device 100 may also include a magnetometer 169. FIGS. 1A and 1B show a magnetometer 169 coupled to the peripherals interface 118. Alternately, the magnetometer 169 may be coupled to an input controller 160 in the I/O subsystem 106. The magnetometer is used to determine the orientation of the device, as well as bearing information.

The device 100 may also include a GPS receiver 170. FIGS. 1A and 1B show a GPS 170 coupled to the peripherals interface 118. Alternately, the GPS 170 may be coupled to an input controller 160 in the I/O subsystem 106. The GPS is one component used to determine the location of the device, as well as all available location-based information, and provides this information for use in various applications, including GPS module 135.

In some embodiments, the software components stored in memory 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

The operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple, Inc.) devices.

The contact/motion module 130 may detect contact with the touch screen 112 (in conjunction with the display controller 156) and other touch sensitive devices (e.g., a touchpad or physical click wheel). The contact/motion module 130 includes various software components for performing various operations related to detection of contact, such as determining if contact has occurred (e.g., detecting a finger-down event), determining if there is movement of the contact and tracking the movement across the touch-sensitive surface (e.g., detecting one or more finger-dragging events), and determining if the contact has ceased (e.g., detecting a finger-up event or a break in contact). The contact/motion module 130 receives contact data from the touch-sensitive surface. Determining movement of the point of contact, which is represented by a series of contact data, may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module 130 and the display controller 156 detects contact on a touchpad. In some embodiments, the contact/motion module 130 and the controller 160 detects contact on a click wheel.

The contact/motion module 130 may detect a gesture input by a user. Different gestures on the touch-sensitive surface have different contact patterns. Thus, a gesture may be detected by detecting a particular contact pattern. For example, detecting a finger tap gesture includes detecting a finger-down event followed by detecting a finger-up event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up event.

The graphics module 132 includes various known software components for rendering and displaying graphics on the touch screen 112 or other display, including components for changing the intensity of graphics that are displayed. As used herein, the term “graphics” includes any object that can be displayed to a user, including without limitation text, web pages, icons (such as user-interface objects including soft keys), digital images, videos, animations and the like.

In some embodiments, the graphics module 132 stores data representing graphics to be used. Each graphic may be assigned a corresponding code. The graphics module 132 receives, from applications etc., one or more codes specifying graphics to be displayed along with, if necessary, coordinate data and other graphic property data, and then generates screen image data to output to display controller 156.

The text input module 134, which may be a component of graphics module 132, provides soft keyboards for entering text in various applications (e.g., contacts 137, e-mail 140, IM 141, browser 147, and any other application that needs text input).

The GPS module 135, which relies on GPS receiver 170, determines the location of the device, as well as all available location-based information, and provides this information for use in various applications (e.g., to telephone 138 for use in location-based dialing, to camera 143 as picture/video metadata, and to applications that provide location-based services such as weather widgets, local yellow page widgets, map/navigation widgets, and any applications or widgets suitable for editing or creating electronic documents, such as word processing module 384 and spreadsheet module 390).

The applications 136 may include the following modules (or sets of instructions), or a subset or superset thereof:
a contacts module 137 (sometimes called an address book or contact list);
a telephone module 138;
a video conferencing module 139;
an e-mail client module 140;
an instant messaging (IM) module 141;
a workout support module 142;
a camera module 143 for still and/or video images;
an image management module 144;
a video player module 145;
a music player module 146;
a browser module 147;
a calendar module 148;
widget modules 149, which may include weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module 145 and music player module 146;
notes module 153;
map module 154; and/or
online video module 155.

Examples of other applications 136 that may be stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact module 130, graphics module 132, and text input module 134, the contacts module 137 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, the telephone module 138 may be used to enter a sequence of characters corresponding to a telephone number, access one or more telephone numbers in the address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, the videoconferencing module 139 may be used to initiate, conduct, and terminate a video conference between a user and one or more other participants.

In conjunction with RF circuitry 108, touch screen 112, display controller 156, contact module 130, graphics module 132, and text input module 134, the e-mail client module 140 may be used to create, send, receive, and manage e-mail. In conjunction with image management module 144, the e-mail module 140 makes it very easy to create and send e-mails with still or video images taken with camera module 143.

In conjunction with RF circuitry 108, touch screen 112, display controller 156, contact module 130, graphics module 132, and text input module 134, the instant messaging module 141 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, GPS module 135, map module 154, and music player module 146, the workout support module 142 may be used to create workouts (e.g., with time, distance, and/or calorie burning goals); communicate with workout sensors (sports devices); receive workout sensor data; calibrate sensors used to monitor a workout; select and play music for a workout; and display, store and transmit workout data.

In conjunction with touch screen 112, display controller 156, optical sensor(s) 164, optical sensor controller 158, contact module 130, graphics module 132, and image management module 144, the camera module 143 may be used to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, the image management module 144 may be used to arrange, modify (e.g., edit), or otherwise manipulate, label, delete, present (e.g., in a digital slide show or album), and store still and/or video images.

In conjunction with touch screen 112, display controller 156, contact module 130, graphics module 132, audio circuitry 110, and speaker 111, the video player module 145 may be used to display, present or otherwise play back videos (e.g., on the touch screen or on an external, connected display via external port 124).

In conjunction with touch screen 112, display system controller 156, contact module 130, graphics module 132, audio circuitry 110, speaker 111, RF circuitry 108, and browser module 147, the music player module 146 allows the user to download and play back recorded music and other sound files stored in one or more file formats, such as MP3 or AAC files. In some embodiments, the device 100 may include the functionality of an MP3 player, such as an iPod (trademark of Apple, Inc.).

In conjunction with RF circuitry 108, touch screen 112, display system controller 156, contact module 130, graphics module 132, and text input module 134, the browser module 147 may be used to browse the Internet, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail module 140, and browser module 147, the calendar module 148 may be used to create, display, modify, and store calendars and data associated with calendars (e.g., calendar entries, to do lists, etc.).

In conjunction with RF circuitry 108, touch screen 112, display system controller 156, contact module 130, graphics module 132, text input module 134, and browser module 147, the widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, the search module 151 may be used to search for text, music, sound, image, video, and/or other files in memory 102 that match one or more search criteria (e.g., one or more user-specified search terms).

In conjunction with touch screen 112, display controller 156, contact module 130, graphics module 132, and text input module 134, the notes module 153 may be used to create and manage notes, to do lists, and the like.

In conjunction with RF circuitry 108, touch screen 112, display system controller 156, contact module 130, graphics module 132, text input module 134, GPS module 135, and browser module 147, the map module 154 may be used to receive, display, modify, and store maps and data associated with maps (e.g., driving directions; data on stores and other points of interest at or near a particular location; and other location-based data).

In conjunction with touch screen 112, display system controller 156, contact module 130, graphics module 132, audio circuitry 110, speaker 111, RF circuitry 108, text input module 134, e-mail client module 140, and browser module 147, the online video module 155 allows the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the content of which is hereby incorporated by reference in its entirety.

Each of the above identified modules and applications corresponds to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various embodiments. For example, video player module 145 may be combined with music player module 146 into a single module (e.g., video and music player module 152, FIG. 1B). In some embodiments, memory 102 may store a subset of the modules and data structures identified above. Furthermore, memory 102 may store additional modules and data structures not described above.

In some embodiments, the device 100 is a device where operation of a predefined set of functions on the device is performed exclusively through a touch screen 112 and/or a touchpad. By using a touch screen and/or a touchpad as the primary input/control device for operation of the device 100, the number of physical input/control devices (such as push buttons, dials, and the like) on the device 100 may be reduced.

The predefined set of functions that may be performed exclusively through a touch screen and/or a touchpad include navigation between user interfaces. In some embodiments, the touchpad, when touched by the user, navigates the device 100 to a main, home, or root menu from any user interface that may be displayed on the device 100. In such embodiments, the touchpad may be referred to as a “menu button.” In some other embodiments, the menu button may be a physical push button or other physical input/control device instead of a touchpad.

FIG. 2 illustrates a portable multifunction device 100 having a touch screen 112 in accordance with some embodiments. The touch screen may display one or more graphics within user interface (UI) 200. In this embodiment, as well as others described below, a user may select one or more of the graphics by making contact or touching the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the contact may include a gesture, such as one or more taps, one or more swipes (from left to right, right to left, upward and/or downward) and/or a rolling of a finger (from right to left, left to right, upward and/or downward) that has made contact with the device 100. In some embodiments, inadvertent contact with a graphic may not select the graphic. For example, a swipe gesture that sweeps over an application icon may not select the corresponding application when the gesture corresponding to selection is a tap.

The device 100 may also include one or more physical buttons, such as “home” or menu button 204. As described previously, the menu button 204 may be used to navigate to any application 136 in a set of applications that may be executed on the device 100. Alternatively, in some embodiments, the menu button is implemented as a soft key in a GUI in touch screen 112.

In one embodiment, the device 100 includes a touch screen 112, a menu button 204, a push button 206 for powering the device on/off and locking the device, volume adjustment button(s) 208, a Subscriber Identity Module (SIM) card slot 210, a head set jack 212, and a docking/charging external port 124. The push button 206 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, the device 100 also may accept verbal input for activation or deactivation of some functions through the microphone 113.

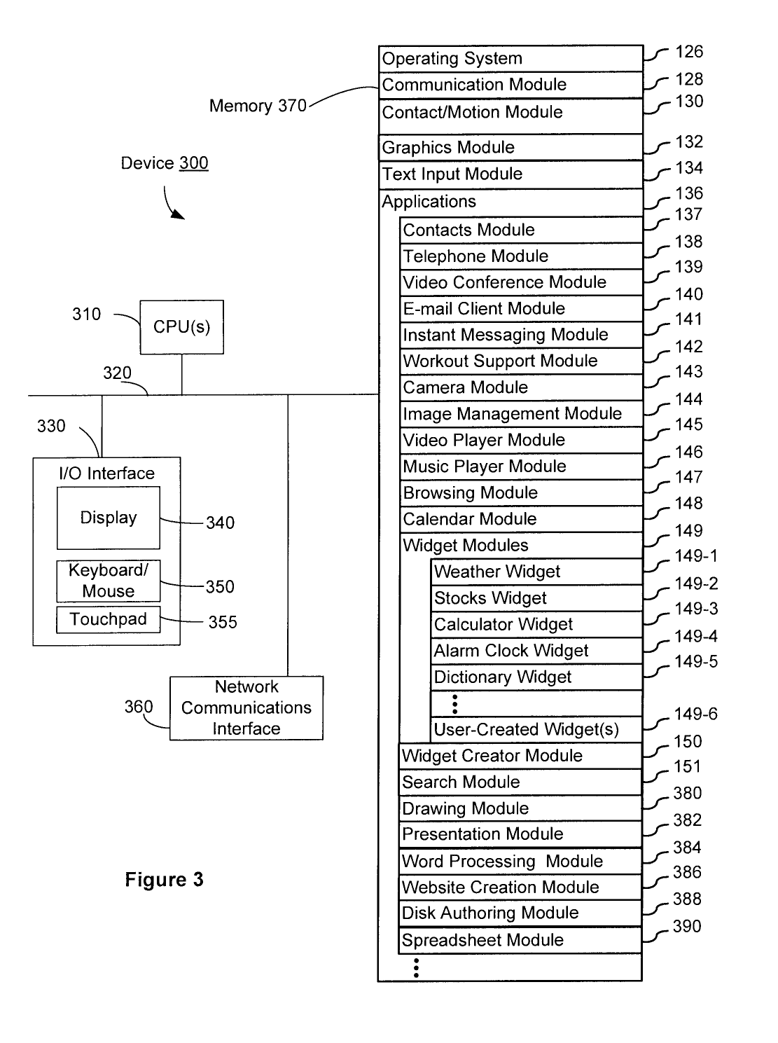

FIG. 3 is a block diagram of an exemplary multifunction device with a display and a touch-sensitive surface in accordance with some embodiments. Device 300 need not be portable. In some embodiments, the device 300 is a laptop computer, a desktop computer, a tablet computer, a multimedia player device, a navigation device, an educational device (such as a child's learning toy), a gaming system, or a control device (e.g., a home or industrial controller). The device 300 typically includes one or more processing units (CPU's) 310, one or more network or other communications interfaces 360, memory 370, and one or more communication buses 320 for interconnecting these components. The communication buses 320 may include circuitry (sometimes called a chipset) that interconnects and controls communications between system components. The device 300 includes a user interface 330 comprising a display 340, which is typically a touch screen display. The user interface 330 also may include a keyboard and/or mouse (or other pointing device) 350 and a touchpad 355. Memory 370 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 370 may optionally include one or more storage devices remotely located from the CPU(s) 310. In some embodiments, memory 370 stores programs, modules, and data structures analogous to the programs, modules, and data structures stored in the memory 102 of portable multifunction device 100 (FIG. 1), or a subset thereof. Furthermore, memory 370 may store additional programs, modules, and data structures not present in the memory 102 of portable multifunction device 100. For example, memory 370 of device 300 may store drawing module 380, presentation module 382, word processing module 384, website creation module 386, disk authoring module 388, and/or spreadsheet module 390, while memory 102 of portable multifunction device 100 (FIG. 1) may not store these modules.

Each of the above identified elements in FIG. 3 may be stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 370 may store a subset of the modules and data structures identified above. Furthermore, memory 370 may store additional modules and data structures not described above.

Attention is now directed towards embodiments of user interfaces (“UI”) that may be implemented on a portable multifunction device 100.

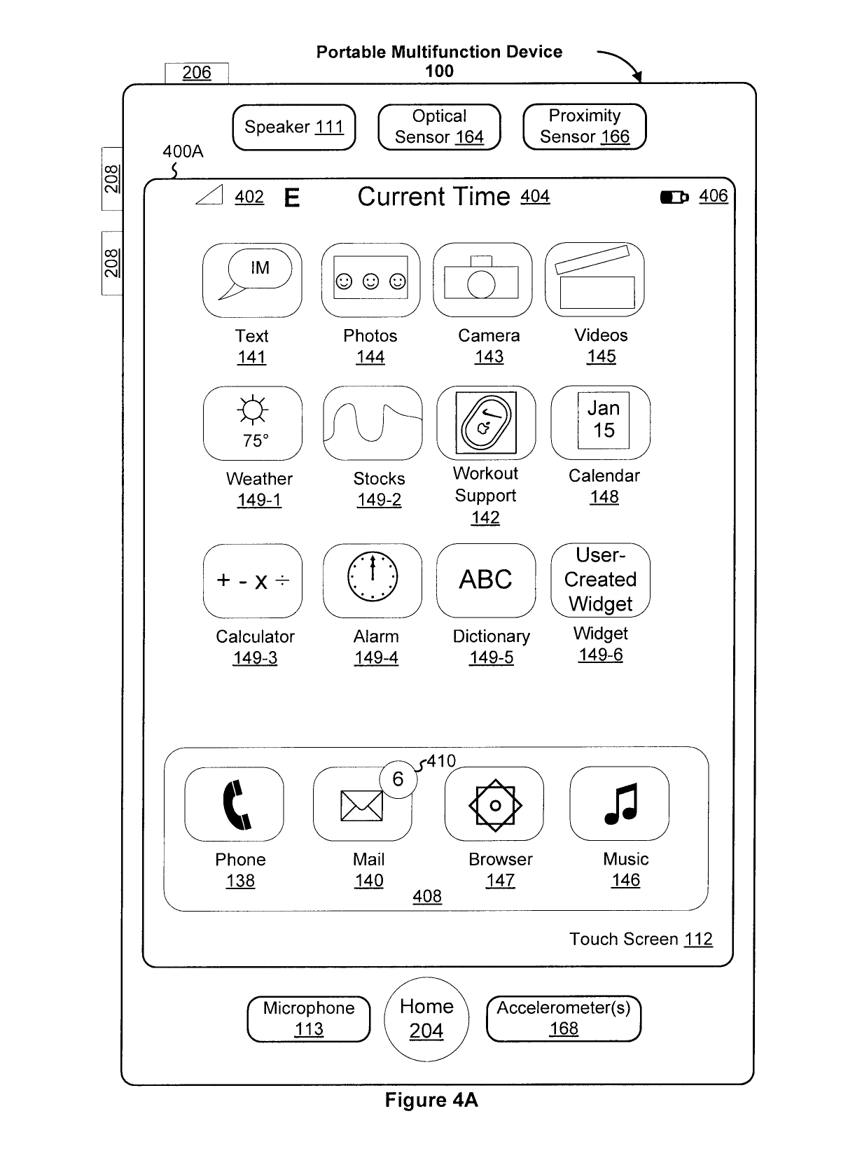

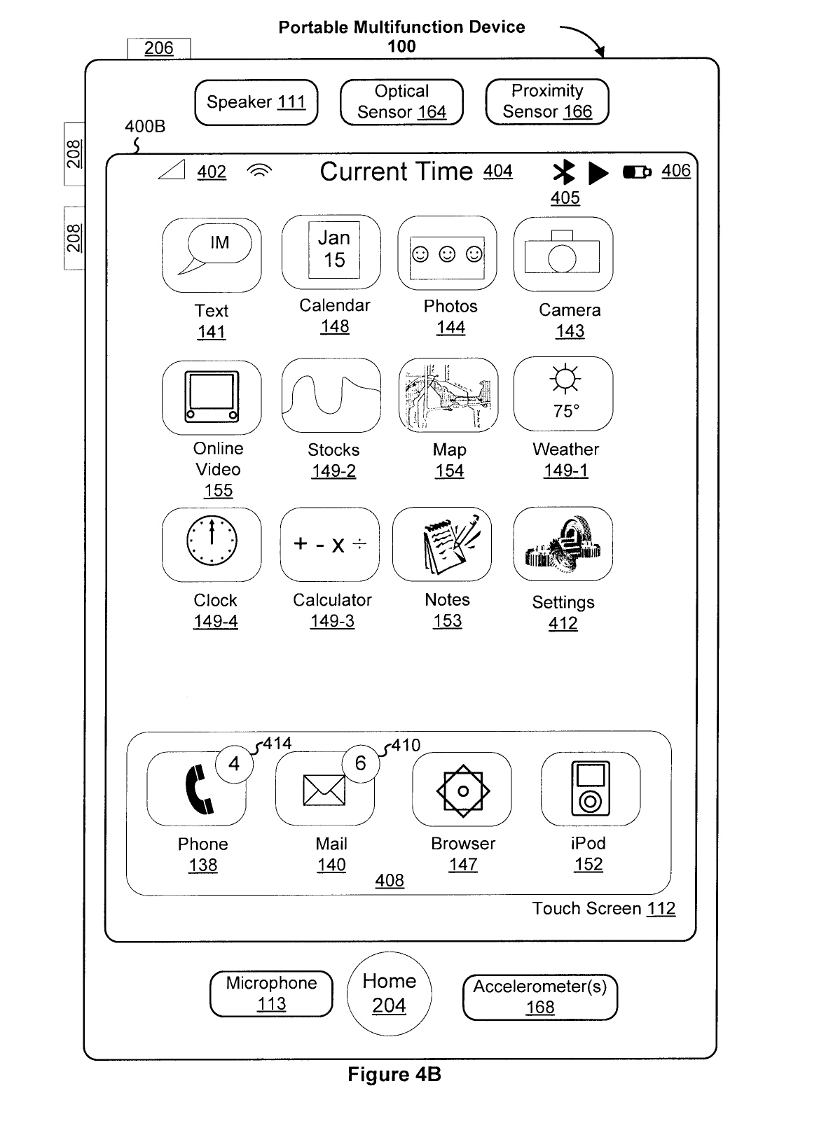

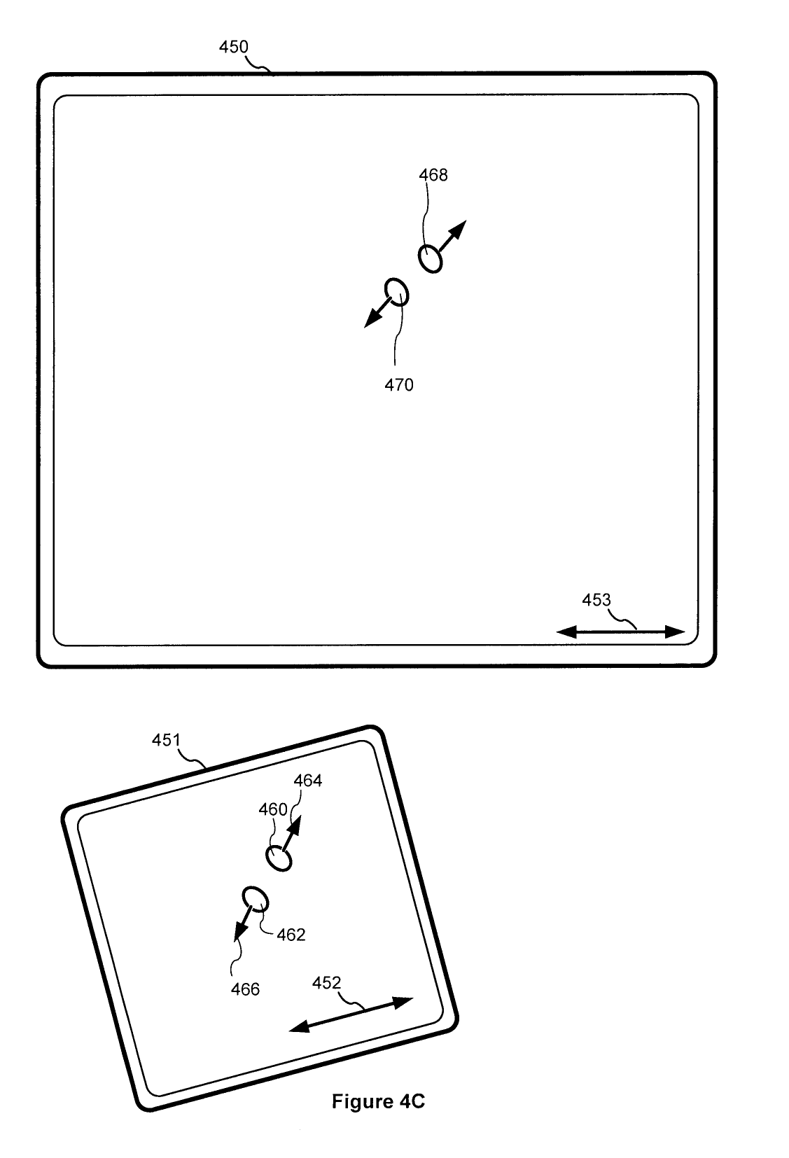

FIGS. 4A and 4B illustrate exemplary user interfaces for a menu of applications on a portable multifunction device 100 in accordance with some embodiments. Similar user interfaces may be implemented on device 300. In some embodiments, user interface 400A includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Phone 138, which may include an indicator 414 of the number of missed calls or voicemail messages;
   E-mail client 140, which may include an indicator 410 of the number of unread e-mails;
   Browser 147; and
   Music player 146; and
Icons for other applications, such as:
   IM 141;
   Image management 144;
   Camera 143;
   Video player 145;
   Weather 149-1;
   Stocks 149-2;
   Workout support 142;
   Calendar 148;
   Calculator 149-3;
   Alarm clock 149-4;
   Dictionary 149-5; and
   User-created widget 149-6.

In some embodiments, user interface 400B includes the following elements, or a subset or superset thereof:

402, 404, 405, 406, 141, 148, 144, 143, 149-3, 149-2, 149-1, 149-4, 410, 414, 138, 140, and 147, as described above;
Map 154;
Notes 153;
Settings 412, which provides access to settings for the device 100 and its various applications 136, as described further below;
Video and music player module 152, also referred to as iPod (trademark of Apple, Inc.) module 152; and
Online video module 155, also referred to as YouTube (trademark of Google, Inc.) module 155.

FIG. 4C illustrates an exemplary user interface on a multifunction device with a separate display (e.g., 450) and touch-sensitive surface (e.g., 451). Although many of the examples which follow will be given with reference to a touch screen display (e.g., where the touch sensitive surface and the display are combined, as shown in device 100 in FIGS. 4A-4B), in some embodiments the display and the touch-sensitive surface are separate, as shown in FIG. 4C. In some embodiments the touch sensitive surface (e.g., 451 in FIG. 4C) has a primary axis (e.g., 452 in FIG. 4C) that corresponds to a primary axis (e.g., 453 in FIG. 4C) on the display (e.g., 450). In accordance with these embodiments, the device detects contacts (e.g., 460 and 462 in FIG. 4C) with the touch-sensitive surface 451 at locations that correspond to respective locations on the display (e.g., in FIG. 4C 460 corresponds to 468 and 462 corresponds to 470). In this way, user inputs (e.g., contacts 460 and 462) detected by the device on the touch-sensitive surface (e.g., 451 in FIG. 4C) are used by the device to manipulate the user interface on the display (e.g., 450 in FIG. 4C) of the multifunction device when the touch-sensitive surface and the display are separate. It should be understood that similar methods may be used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture may be replaced with a mouse click (e.g., instead of a contact) followed by movement of the cursor along the path of the swipe (e.g., instead of movement of the contact). As another example, a tap gesture may be replaced with a mouse click while the cursor is located over the location of the tap gesture (e.g., instead of detection of the contact followed by ceasing to detect the contact). Similarly, when multiple user inputs are simultaneously detected, it should be understood that multiple computer mice may be used simultaneously, or a mouse and finger contacts may be used simultaneously.

Attention is now directed towards embodiments of user interfaces (“UI”) and associated processes that may be implemented on a multifunction device with a display and a touch-sensitive surface, such as device 300 or portable multifunction device 100.

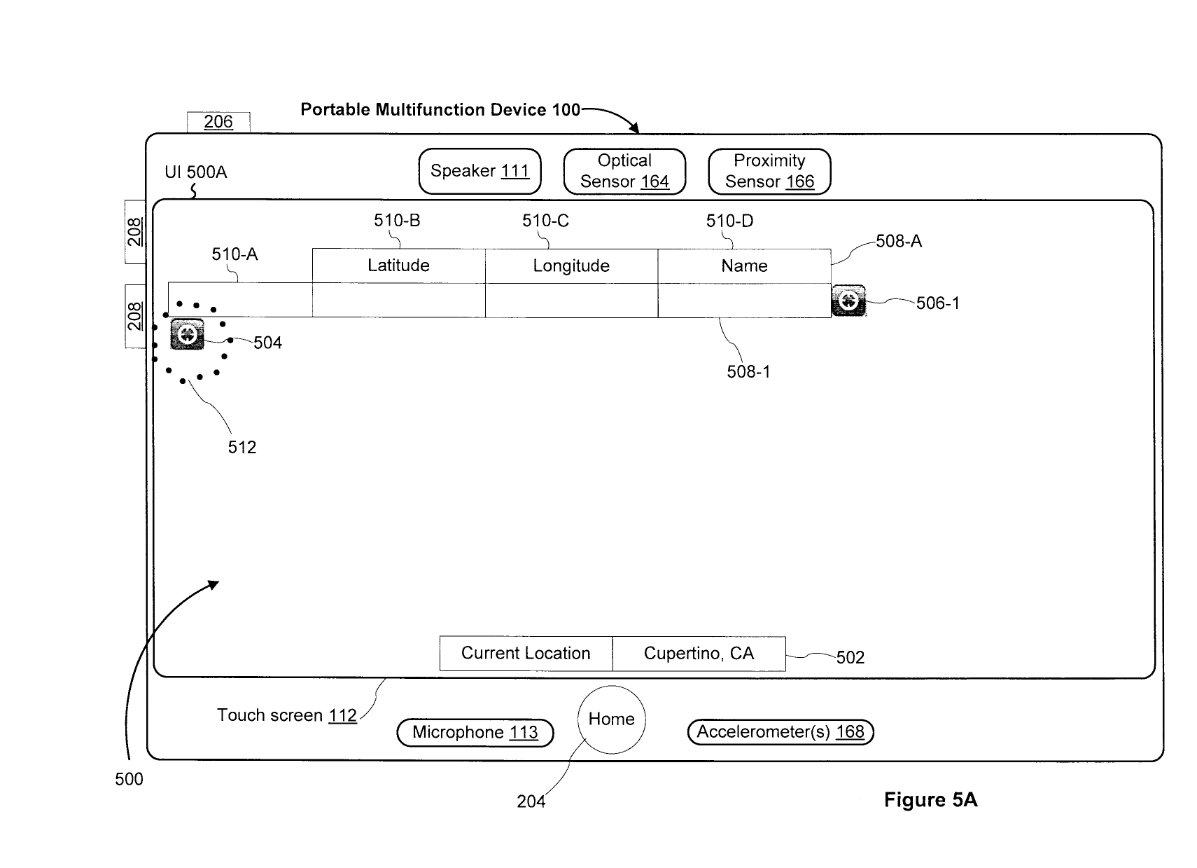

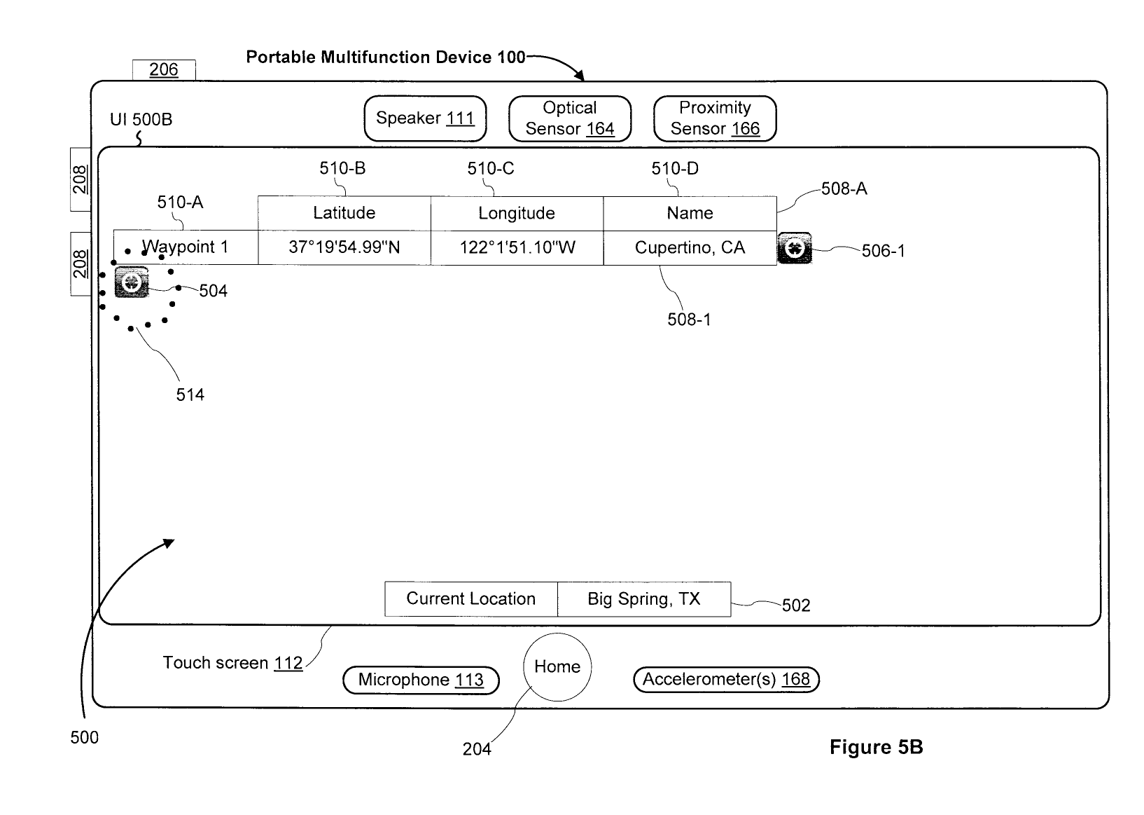

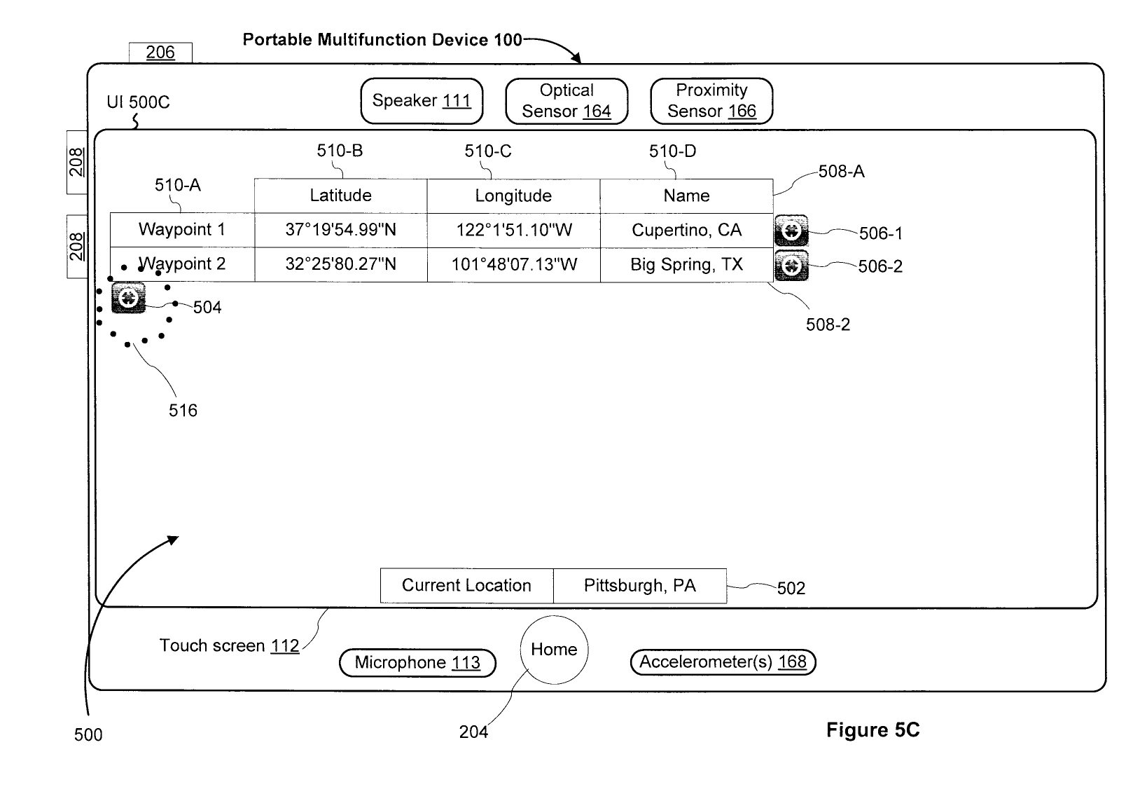

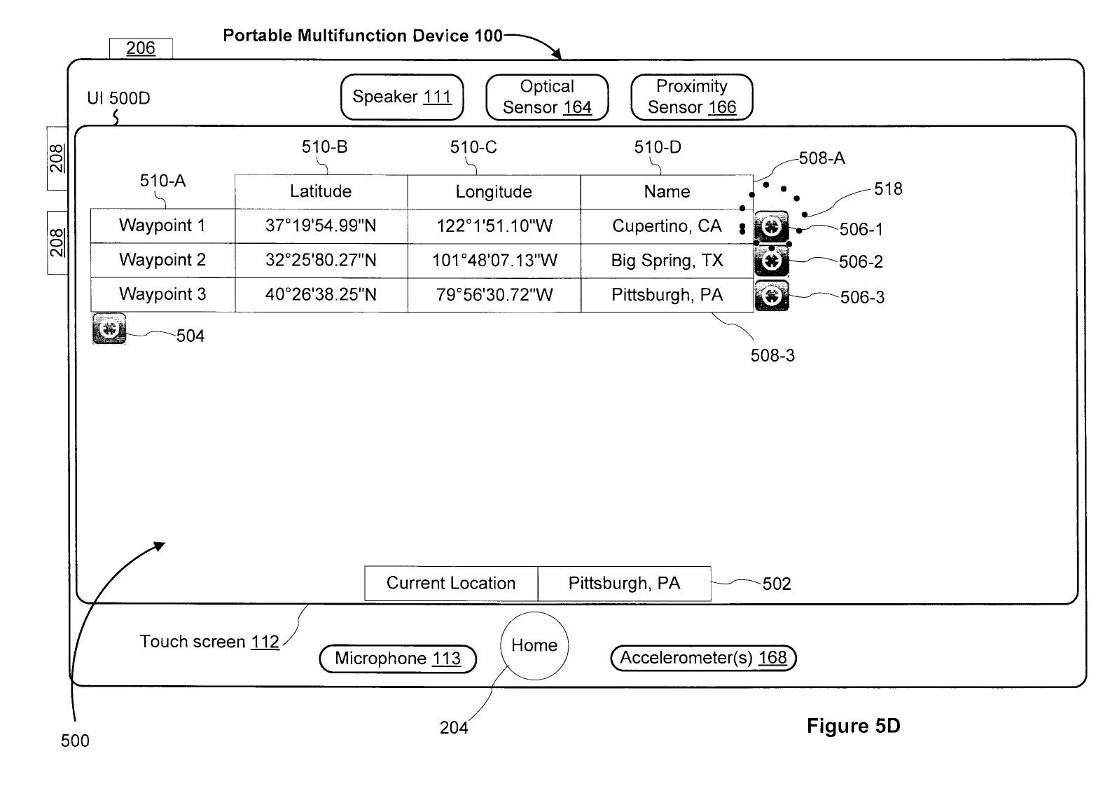

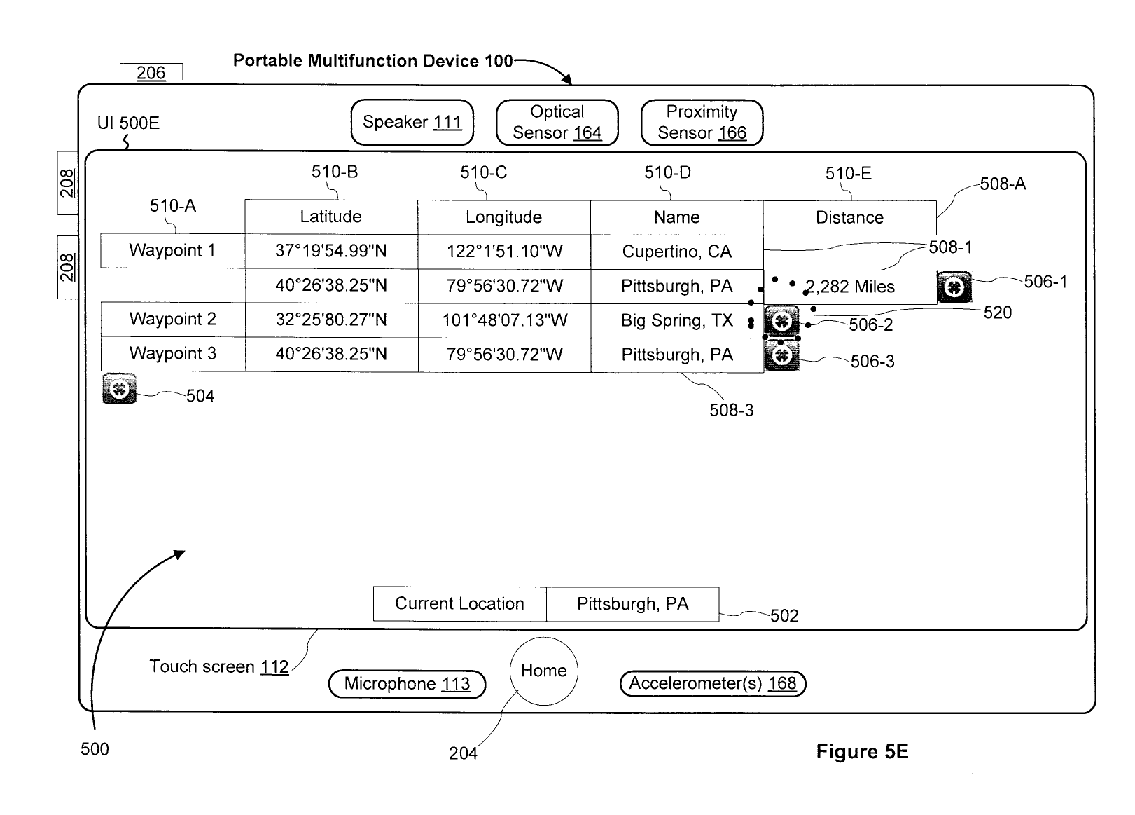

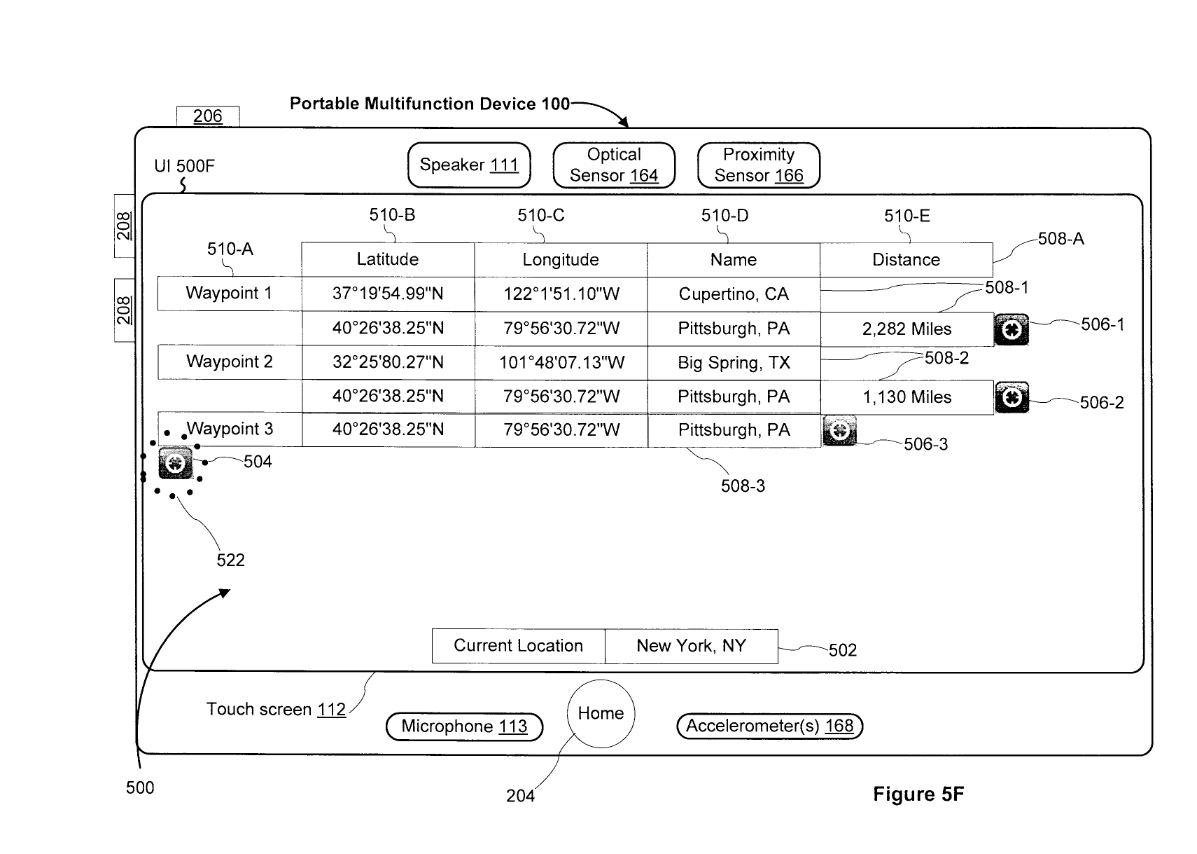

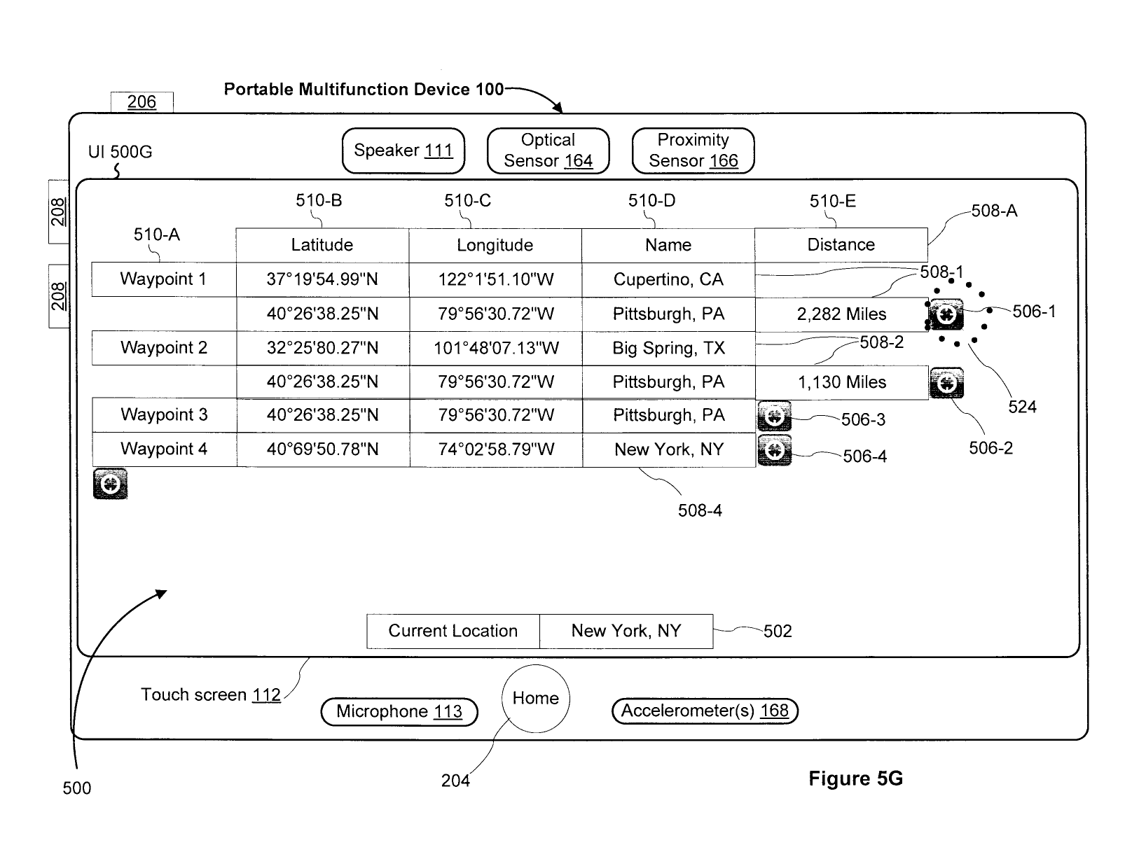

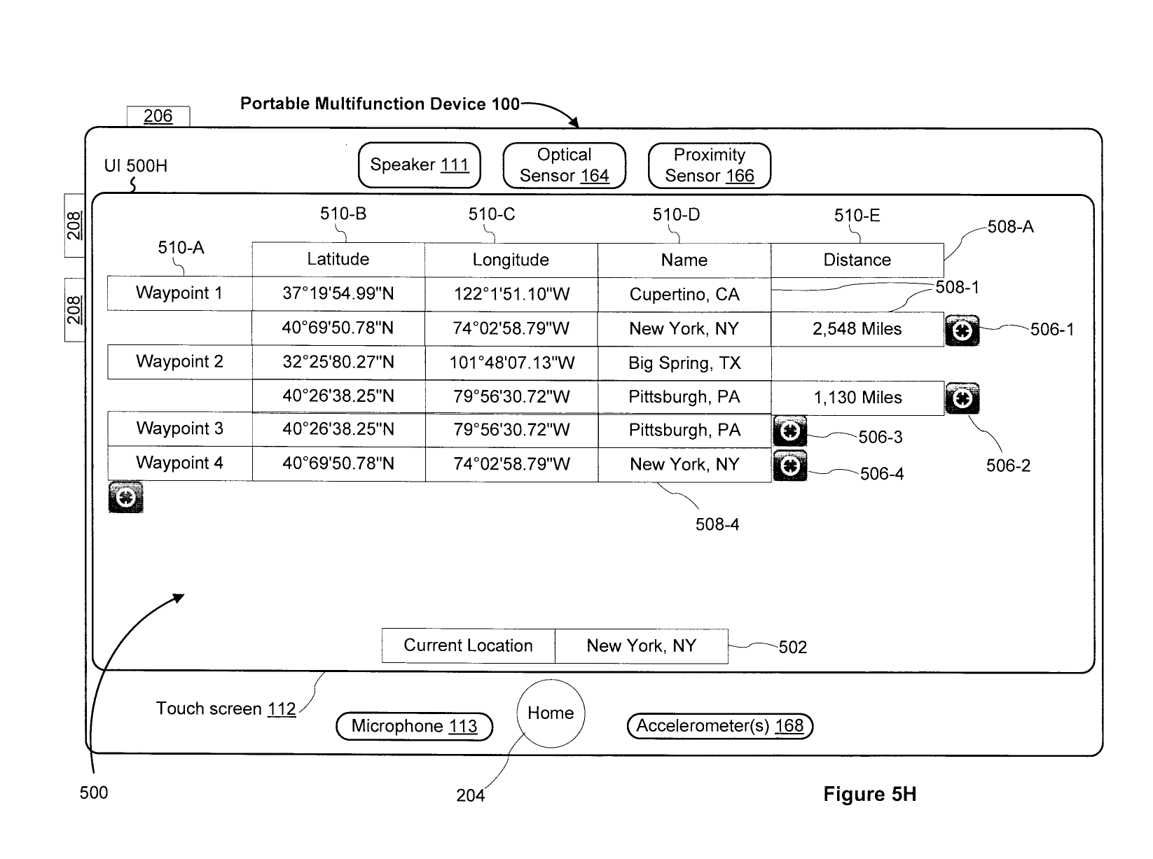

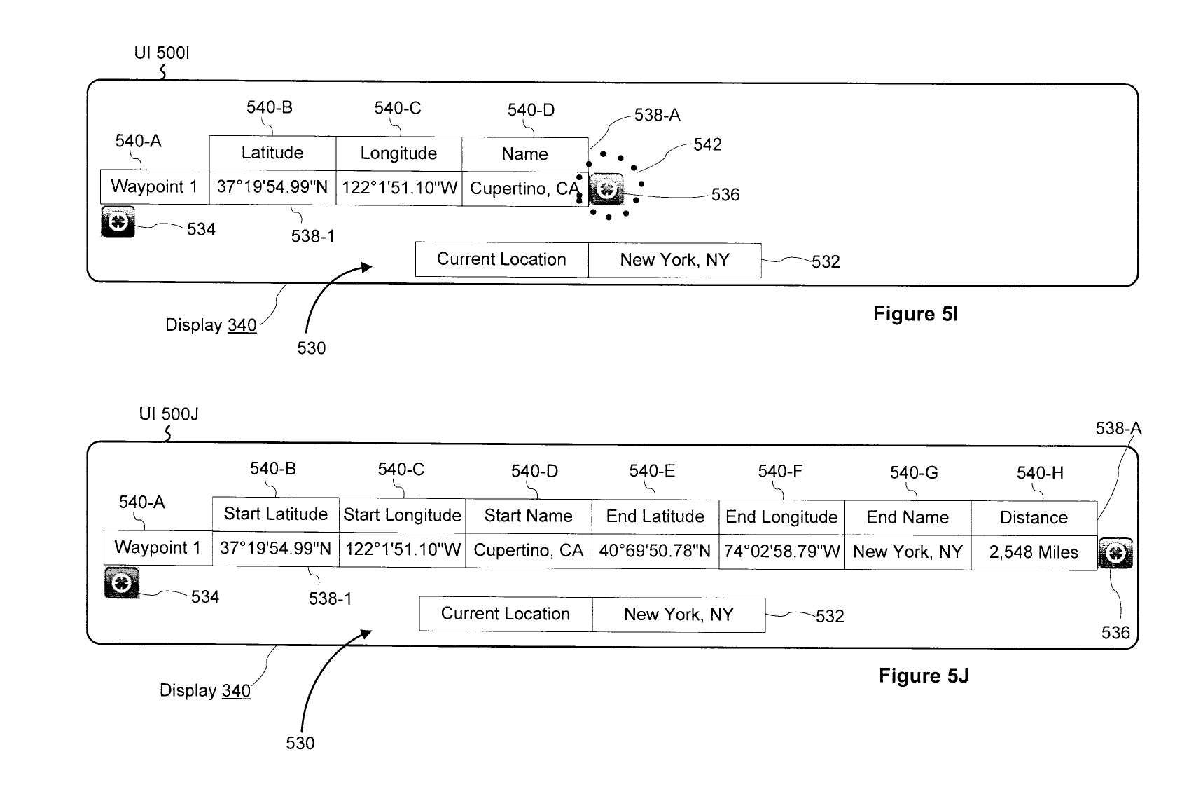

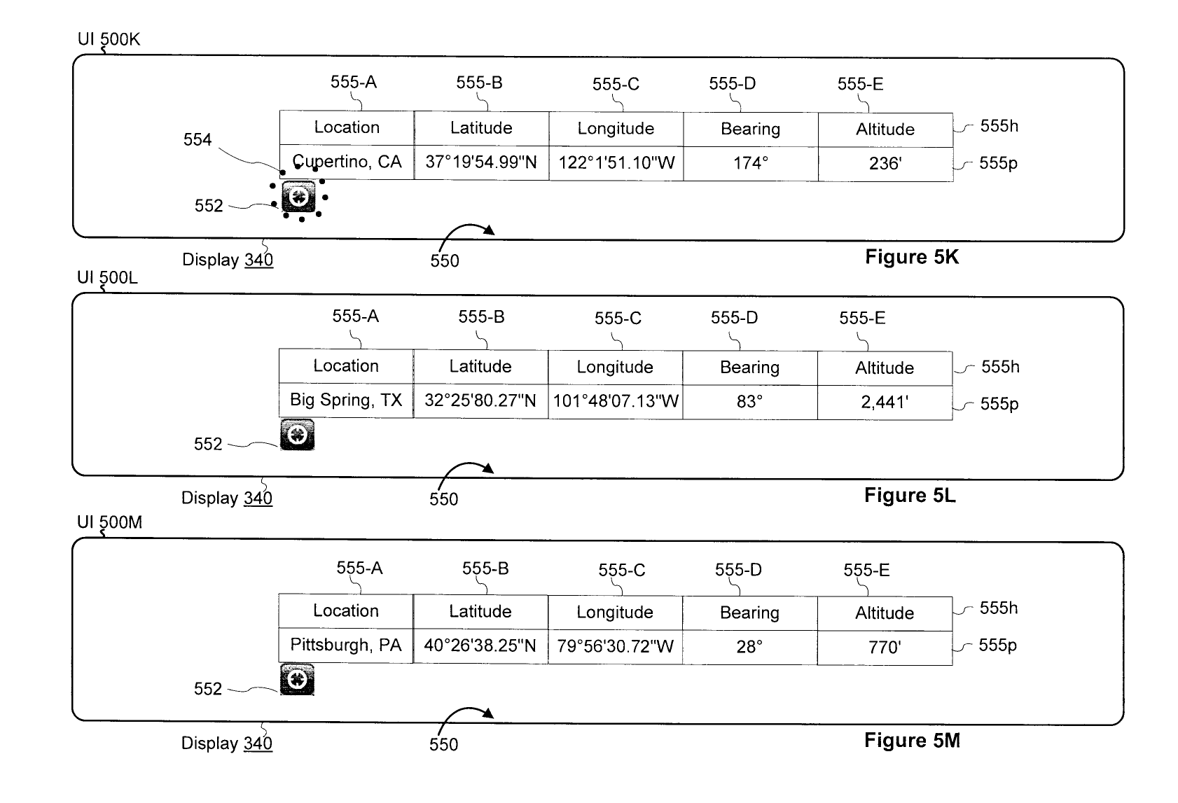

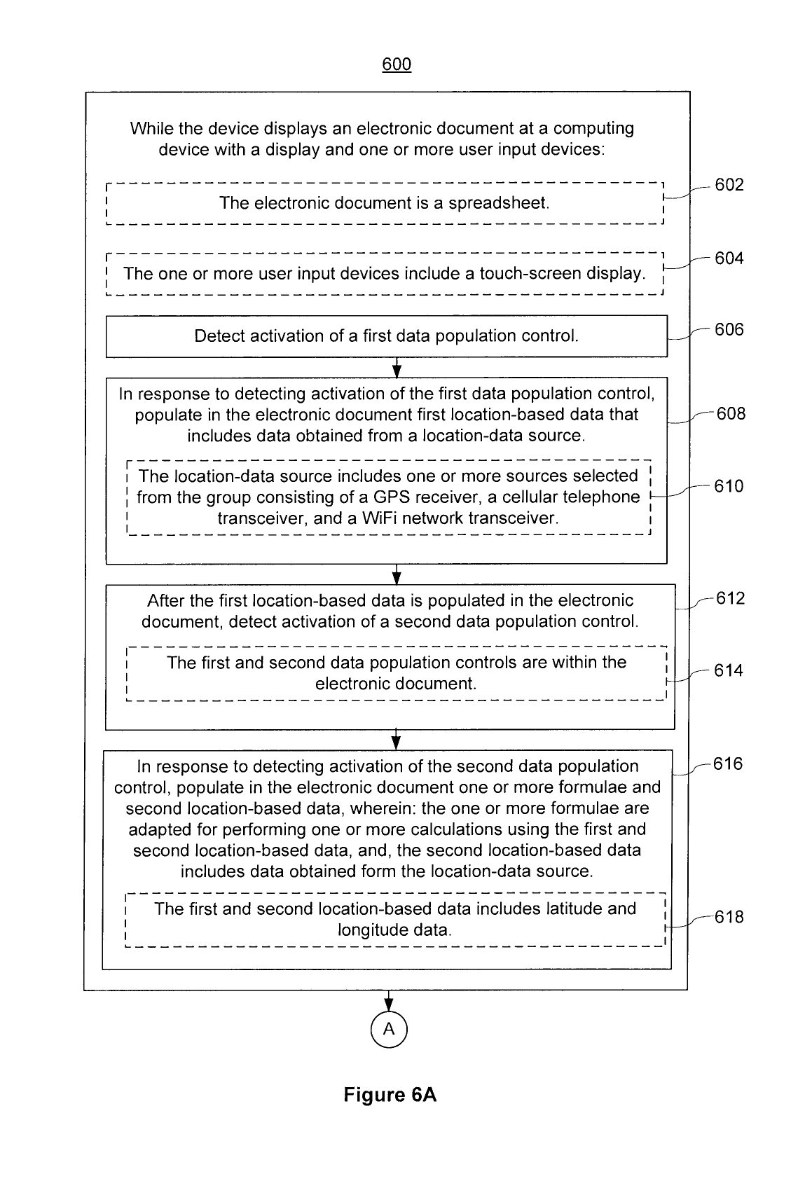

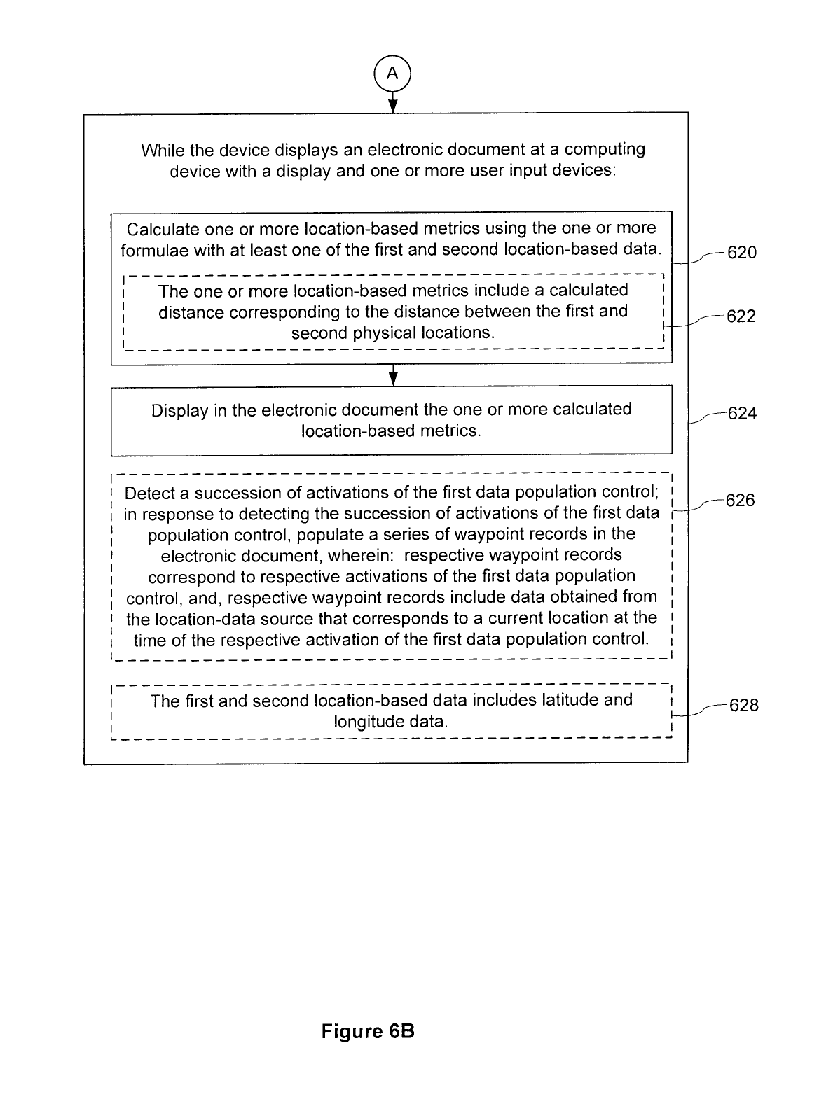

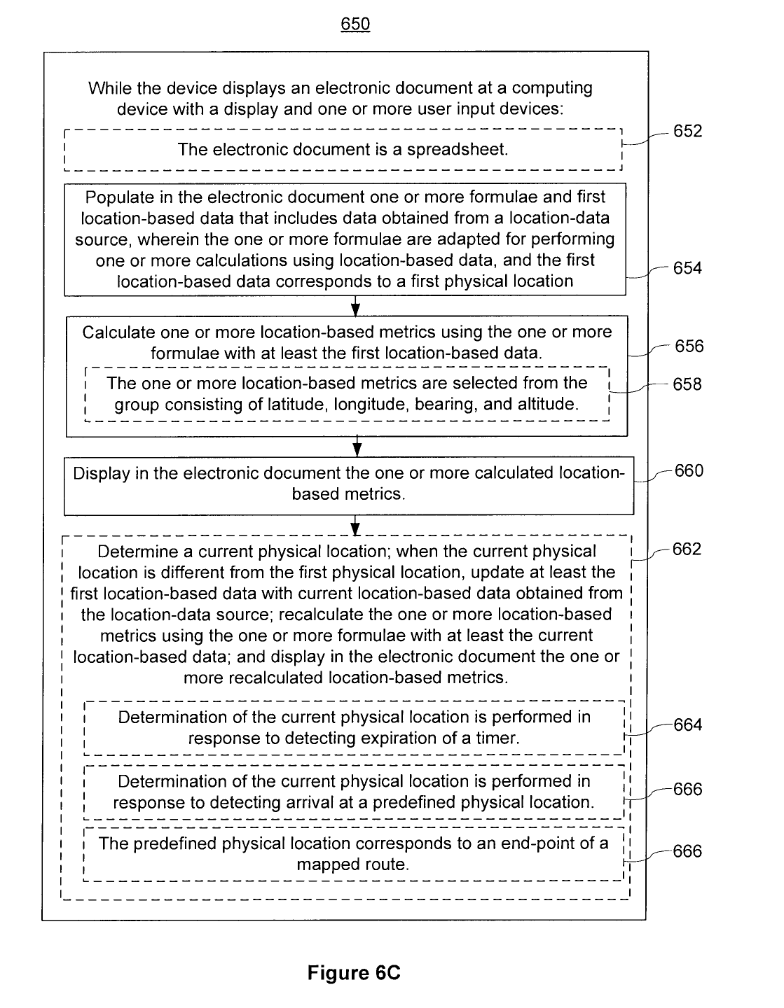

FIGS. 5A-5M illustrate exemplary user interfaces for automated population of location-based data and formulae in electronic documents in accordance with some embodiments. The user interfaces in these figures are used to illustrate the processes described below, including the processes in FIGS. 6A-6B.

UI 500A (FIG. 5A) illustrates an exemplary user interface on a computing device, here portable multifunction device 100 with touch screen 112. An electronic document 500 is displayed on the touch screen 112 of the device 100 by an application module discussed above, such as spreadsheet module 390, word processing module 384, or any suitable application module for creation or editing of electronic documents where a user may wish to automatically populate location-based data and formulae.

UI 500A also illustrates that the exemplary user interface for creating or editing electronic document 500 includes a current location indicia 502, which indicates that the current location of device 100 is Cupertino, Calif.

In this example, electronic document 500 includes first data population control 504 and second data population control 506-1, which are adjacent to data rows 508 within electronic document 500. Data rows 508 currently displayed in electronic document 500 include a header row 508-A and a first data row 508-1, which is currently not populated with any location-based data. In this exemplary embodiment, data rows 508 include waypoint column 510-A, latitude column 510-B, longitude column 510-C, and name column 510-D.

UI 500A also illustrates activation 512 of first data population control 504. Note that at the time of the activation 512, the device 100 is physically located in Cupertino, as reflected by current location indicia 502.

UI 500B (FIG. 5B) illustrates that in response to detecting the activation 512 of first data population control 504 in UI 500A, data row 508-1 is populated with location-based data obtained from a location-data source. Specifically, in this example, latitude, longitude, and place name information corresponding to the location of the device 100 at the time of activation 512, i.e., Cupertino, are populated in the latitude column 510-B, longitude column 510-C, and name column 510-D of data row 508-1, respectively. Additionally, a waypoint tag “Waypoint 1” is populated in the waypoint column 510-A of data row 508-1.

Though travel is not depicted in the figures, UI 500B indicates that after activation 512, the device 100 has been moved to a new geographic location; namely, current location indicia 502 indicates that the current location of device 100 is Big Spring, Tex.

UI 500B also illustrates another activation 514 of first data population control 504. Note that at the time of the activation 514, the device 100 is physically located in Big Spring, as reflected by current location indicia 502.

UI 500C (FIG. 5C) illustrates that in response to detecting the activation 514 of first data population control 504 in UI 500B, data row 508-2 is populated with location-based data obtained from a location-data source. Specifically, in this example, latitude, longitude, and place name information corresponding to the location of the device 100 at the time of activation 514, i.e., Big Spring, are populated in the latitude column 510-B, longitude column 510-C, and name column 510-D of data row 508-2, respectively. Additionally, a waypoint tag “Waypoint 2” is populated in the waypoint column 510-A of data row 508-2.

As noted above, travel is not depicted in the figures, but UI 500C indicates that after activation 514, the device 100 has been moved to a new geographic location; namely, current location indicia 502 indicates that the current location of device 100 is Pittsburgh, Pa.

UI 500C also illustrates another activation 516 of first data population control 504. Note that at the time of the activation 516, the device 100 is physically located in Pittsburgh, as reflected by current location indicia 502.

UI 500D (FIG. 5D) illustrates that in response to detecting the activation 516 of first data population control 504 in UI 500C, data row 508-3 is populated with location-based data obtained from a location-data source. Specifically, in this example, latitude, longitude, and place name information corresponding to the location of the device 100 at the time of activation 516, i.e., Pittsburgh, are populated in the latitude column 510-B, longitude column 510-C, and name column 510-D of data row 508-3, respectively. Additionally, a waypoint tag “Waypoint 3” is populated in the waypoint column 510-A of data row 508-3.

UI 500D also illustrates activation 518 of second data population control 506-1. Note that at the time of activation 518, the device 100 is physically located in Pittsburgh, as reflected by current location indicia 502.

UI 500E (FIG. 5E) illustrates that in response to detecting the activation 518 of second data population control 506-1, data row 508-1 is expanded to include second location-based data. In this exemplary embodiment, electronic document 500 has a table that includes data rows 508 which expand to include location-based data obtained from a location-data source, the location-based data corresponding to the location of the device 100 at the time of activation of a second data population control (e.g., activation 518 of second data population control 506-1). Specifically, in the expanded data row 508-1, second location-based data in the form of current location information is populated (i.e., the device 100's physical location, Pittsburgh, is populated).

Additionally, some embodiments include populating in the electronic document one or more formulae when a data row is expanded in response to detecting activation of a second data population control. In this example, the one or more formulae are adapted for performing one or more calculations of location-based metrics using the first and second location-based data, such as populating a formula in Distance column 510-E of data row 508-1, which calculates a distance between a location recorded as waypoint 1 in data row 508-1 and the current location of the device 100 (which is reflected by current location indicia 502).

Though the location-based metric displayed in UI 500E's data row 508-1 is a calculated result, i.e., the distance between Cupertino and Pittsburgh, it should be noted that in some embodiments, when a formula is populated in response to detecting activation of a second data population control, the formula may be displayed instead of a calculated result. In some embodiments, a user option (not depicted) may be used to configure whether calculated results or formulae are displayed within the electronic document 500.

Many forms of data and/or formulae may be populated in electronic documents according to the methods and techniques disclosed herein. Though the exemplary user interfaces presented in FIGS. 5A-5J illustrate calculating distance between waypoints, any suitable data that can be collected from a location-data source may be used. For example, GPS systems emit location-based data that can be used to calculate many location-based metrics, including elevation above sea level, elevation above the ground at the current location, current and/or average ground speed, current and/or average air speed, relative elevation differences between two locations, great circle distance between two locations, distance between two locations using a user-selected or a user-defined map route, distance between two locations using the actual route traveled, direction in which the device is traveling, etc. Accordingly, any location-based data emitted from a location-data source may be used to calculate a variety of location-based metrics.

Note that in this exemplary embodiment, electronic document 500 includes first data population control 504 and individual second data population controls 506-X, where ‘X’ corresponds to respective data rows created within electronic document 500. In this example, individual second data population controls are adjacent to respective data rows 508 within electronic document 500, i.e., data row 508-1 has a second data population control 506-1 adjacent to data row 508-1; data row 508-2 has a second data population control 506-2 adjacent to data row 508-2, etc. In alternative embodiments, a single second data population control may be provided that controls updating one or more displayed, calculated location-based metrics, second location-based data, and formulae.

UI 500E also illustrates activation 520 of second data population control 506-2. Note that at the time of activation 520, the device 100 is still physically located in Pittsburgh, as reflected by current location indicia 502.

UI 500F (FIG. 5F) illustrates that, in a similar fashion to the expansion of data row 508-1 in UI 500E, in response to detecting the activation 520 of second data population control 506-2, data row 508-2 is expanded to include one or more formulae and second location-based data. Here, the second location-based data of the current location of Pittsburgh, and the location-based metric of distance between Big Spring and Pittsburgh, are populated.

As noted above, travel is not depicted in the figures, but UI 500F indicates that after activation 520, the device 100 has been moved to a new geographic location; namely, current location indicia 502 indicates that the current location of device 100 is New York, N.Y. Display of current location indicia 502 is optional in some embodiments.

UI 500F also illustrates another activation 522 of first data population control 504. Note that at the time of the activation 522, the device 100 is physically located in New York, as reflected by current location indicia 502.

UI 500G (FIG. 5G) illustrates that in response to detecting the activation 522 of first data population control 504 in UI 500F, data row 508-4 is populated with location-based data obtained from a location-data source. Specifically, in this example, latitude, longitude, and place name information corresponding to the location of the device 100 at the time of activation 512, i.e., New York, are populated in the latitude column 510-B, longitude column 510-C, and name column 510-D of data row 508-4, respectively. Additionally, a waypoint tag “Waypoint 4” is populated in the waypoint column 510-A of data row 508-4.

UI 500G also illustrates a second activation 524 of second data population control 506-1.

UI 500H (FIG. 5H) illustrates that in response to detecting the second activation 524 of second data population control 506-1, data row 508-1 is updated with second location-based data corresponding to the location of device 100 at the time of the activation 524. Specifically, in the expanded data row 508-1, second location-based data in the form of current location information is populated (i.e., the device 100's physical location, New York, is populated). Additionally, because at least one of the first and second location-based data in data row 508-1 has changed, the location-based metric in column 510-E is calculated again using the updated location-based data in data row 508-1. Accordingly, the calculated location-based metric in column 510-E is updated and displayed to reflect the distance between Waypoint 1, Cupertino, and the current location, New York.

UI 500I-UI 500J (FIGS. 5I-5J) illustrate an alternative, exemplary user interface on the display 340 of a computing device 300 (for purposes of clarity, only the display 340 of computing device 300 is depicted).

As shown in UI 500I, an electronic document 530 is displayed on the display 340 by an application module discussed above, such as spreadsheet module 390, word processing module 384, or any suitable application module for creation or editing of electronic documents where a user may wish to automatically populate location-based data and formulae.

UI 500I also illustrates that the exemplary user interface for creating or editing electronic document 530 includes a current location indicia 532, which indicates that the current location of computing device 300 is New York, N.Y. Display of current location indicia 532 is optional in some embodiments.

In this example, electronic document 530 includes first data population control 534 and second data population control 536, which are adjacent to data rows 538 within electronic document 530. Data rows 538 currently displayed in electronic document 530 include a header row 538-A and a first data row 538-1, which is currently populated with location-based data stored when the device 300 was physically located in Cupertino, Calif. (not depicted). In this exemplary embodiment, data rows 538 include waypoint column 540-A, latitude column 540-B, longitude column 540-C, and name column 540-D.

UI 500I also illustrates an exemplary activation 542 of second data population control 536. Activation 542 may be accomplished by a user with any suitable method, including making a point of contact on a touch screen display, where the point of contact is over second data population control 536; using a mouse-button click to activate second data population control 536, etc.

UI 500J illustrates that in response to detecting the activation 542 of second data population control 542 in UI 500I, data row 538-1 is expanded to include one or more formulae and second location-based data. Here, the second location-based data of the current location of New York and the location-based metric of distance 540-H between Cupertino and New York are populated.

Note that in the exemplary embodiment of UI 500J, the header row 538-A has been updated to reflect the nature of the expanded data row 538-1, namely, that data row 538-1 includes waypoint column 540-A, start latitude column 540-B, start longitude column 540-C, start name column 540-D, end latitude column 540-E, end longitude column 540-F, end name column 540-G, and distance column 540-H.

UI 500K-UI 500M (FIGS. 5K-5M) illustrate an alternative, exemplary user interface on the display 340 of a computing device 300 (for purposes of clarity, only the display 340 of computing device 300 is depicted).

As shown in UI 500K, an electronic document 550 is displayed on the display 340 by an application module discussed above, such as spreadsheet module 390, word processing module 384, or any suitable application module for creation or editing of electronic documents where a user may wish to automatically populate location-based data and formulae.

UI 500K also illustrates that the exemplary user interface for creating or editing electronic document 550 includes a data population control 552, which is adjacent to data row 555 within electronic document 550. Data row 555 currently displayed in electronic document 530 includes a header row 555h and a first data row 555p, which is populated with location-based data in response to activation 554 of data population control 552 when the device 300 was physically located in Cupertino, Calif. In this exemplary embodiment, data row 555 includes location column 555-A, latitude column 555-B, longitude column 555-C, bearing column 555-D, and altitude column 555-E. Specifically, in this example, place name, latitude, longitude, bearing, and altitude information corresponding to the location and bearing of the device 300 at the time of activation 554, i.e., Cupertino, are populated in the location column 555-A, latitude column 555-B, longitude column 555-C, bearing column 555-D, and altitude column 555-E, respectively.

Though travel is not depicted in the figures, UI 500L illustrates that the device 300 has been moved to a new geographic location, namely Big Spring, Tex. Accordingly, the device 300 determines its current physical location is different from the first physical location of Cupertino as illustrated in UI 500K. As such, the device 300 updates the location-based data corresponding to Cupertino with current location-based data obtained from the location-data source, specifically, data corresponding to Big Spring. The device then recalculates and displays updated location-based metrics, such as bearing displayed in 555-D, using the current location-based data.

In some embodiments, calculated location-based metrics are provided as pre-calculated values for population in the electronic document, e.g., a compass application program may provide a pre-calculated bearing metric for population in the electronic document. Accordingly, in some embodiments, the electronic document need not perform calculations to populate certain location-based data and/or location-based metrics. In some embodiments, the data populated in the electronic document is location-independent, e.g., data corresponding to magnetic north from magnetometer 169 may be populated in the electronic document, and as such, no calculations need be performed before population.

In some embodiments, calculation of location-based metrics is performed by functionality associated with the electronic document, e.g., in a spreadsheet, the distance traveled may be calculated based on updates in location-based data corresponding to the physical location of the device.

UI 500M illustrates an update of location-based data similar to that of the transition from Cupertino to Big Spring, but for travel from Big Spring to Pittsburgh.

Though not displayed in this exemplary embodiment, other metrics, such as total distance traveled or other metrics discussed herein, may also be recalculated, updated and/or displayed, i.e., any location-based metric that can be based on, or calculated with, data provided from location-data sources may be populated, updated, and/or recalculated in electronic document 550.

Note that, in some embodiments, the recalculation and display of updated location-based metrics occurs without user intervention or direct user input. Rather, recalculation and updated display of location-based data occurs when the device 300 is moved to a new location different than the previous location. After the device 300 is at a new location, one or more features of software and/or hardware running on the device determine that the device is located at a new physical location different from the last physical location. In response to determining that the device is located at the new physical location, the device populates updated location-based data corresponding to the new physical location. In embodiments where the updated location-based data is populated in a spreadsheet, the spreadsheet application performs one or more recalculations based on the updated location-based data corresponding to the new physical location.

In some embodiments, the recalculation and display of updated location-based metrics is done on a continuous basis without user intervention or direct user input. The recalculation and display of updated location-based metrics can occur after different events that are independent of user input. Non-limiting examples of these events that are independent of user input include the expiration of a timer, completion of a software routine that updates a device location variable, determination that the device arrived at a new location corresponding to a selected end-point of a map route, etc.

Additionally, some or all of the techniques and methods disclosed herein may be used for automatic-population of data emitted from sensors or components emitting data that is not location-based data, or data emitted from sensors or components that emit both location-based data and data that is not location based-data, e.g., including without limitation, accelerometer(s) 168, proximity sensor 166, magnetometer 169, optical sensor(s) 164, microphone 113, thermometers, thermocouples, hygrometers, voltmeters, ammeters, ohmmeters, seismometers, microphones, speedometers, or any suitable sensor(s), component(s), or combination of suitable sensors and components.

In accordance with some embodiments, a method is performed at a computing device with a display and one or more user input devices adapted to detect user gestures. The method includes while displaying an electronic document, e.g., a spreadsheet, populating in the electronic document one or more formulae and first sensor-generated data that includes data obtained from a sensor, wherein the one or more formulae are adapted for performing one or more calculations using sensor-generated data, and wherein the sensor is selected from the group consisting of an accelerometer, a proximity sensor, a magnetometer, an optical sensor, a microphone, a thermometer, a thermocouple, a hygrometer, a voltmeter, an ammeter, an ohmmeter, a seismometer, a microphone, and a speedometer. The method also includes calculating one or more metrics using the one or more formulae with at least the first sensor-generated data; and displaying in the electronic document the one or more calculated metrics; updating at least the first sensor-generated data with current sensor-generated data obtained from the sensor; recalculating the one or more metrics using the one or more formulae with at least the current sensor-generated data; and displaying in the electronic document the one or more recalculated metrics. In some embodiments, the method includes where updating of the current sensor-generated data is performed in response to detecting expiration of a timer. In some embodiments, the method includes where updating of the current sensor-generated data is performed in response to detecting a change in sensor status, e.g., determining a change in bearing based on magnetometer data, detecting an increase in temperature from a thermometer, etc.

The methods, processes, and user interfaces described herein can be used for many purposes. Non-limiting examples include use by a traveling sales person or a truck driver. In these cases, the methods disclosed herein could be used to track movements with respect to sales routes or delivery routes. For example, as a truck driver stops at each of her scheduled stops, she activates the first data population control, thereby populating waypoints for each of her scheduled stops (e.g., activation 512 in FIG. 5A, activation 514 in FIG. 5B, and activation 516 in FIG. 5C depict a succession of activations of the first data population control 504, which create Waypoints 1, 2, and 3, respectively, in data rows 508-1, 508-2, and 508-3).

Then, as desired, the truck driver can activate a second data population control associated with a desired data row, thereby generating information associated with the respective waypoint and, for example, a current location. This can include population of one or more formulae and second location-based data, which enables the electronic document to display calculated location-based metrics, such as the distance between waypoints and the current location, distance between previously recorded waypoints, etc. This approach provides flexibility. For example, in some embodiments, a user can define custom formulae to incorporate into the electronic document for use in performing calculations to generate user-defined location-based metrics using the customized formulae with at least one of the first and second location-based data. For example, a traveling sales person may want to include formulae that operate on the first and second location-based data to record travel expense data for use in her tax return. A truck driver may wish to define formulae that records the amount of time stopped at locations when freight is being loaded or unloaded. As another example, any user driving long-distances may wish to determine fuel efficiency or average gas mileage across one or more waypoint legs with the assistance of customized formulae, which calculate metrics based on automatically populated location-based data and/or sensor-generated data, as well as user-input data, e.g., user input data specifying how much fuel was put into a vehicle at a waypoint stop, location-based data corresponding to the location of a waypoint stop, sensor-generated data from fuel-consumption sensors, etc.

Additionally, in some embodiments, automatic population of location-based data occurs upon detection of a predefined event, e.g., expiration of a timer. In some embodiments, automatic population of location-based data occurs upon detection of a user-based input within another program. In some embodiments, automatic population of location-based data occurs upon detection of user inputs independent of activating the first or second data population controls, e.g., detection by the accelerometer(s) 168 of a user gesture of shaking the device 100. In some embodiments, automatic population of location-based data occurs upon detection of a change in physical location of the device. In some embodiments, automatic population of location-based data occurs upon detection of arrival of the device at a predefined physical location, e.g., upon detecting that the device is at the end-point of a route mapped by map module 154.

Note that in some embodiments, data created, populated, or stored in electronic documents with techniques described herein may be stored locally and/or transmitted across one or more data networks to computing systems or servers for storage and/or further processing. In some embodiments, remote computing systems or servers are accessed through a cloud computing architecture. Cloud computing may include dynamically scalable, and often virtualized, resources that are provided as a service over the Internet to client devices. The resources may include data storage, software as a service applications executed within the cloud and served to an end-user's device, attached services, e.g., iTunes® from Apple Inc. of Cupertino, Calif., etc.

In some embodiments, device 300 accesses remote computing systems through a cloud to execute remotely provided software application services.

In some embodiments, device 300 accesses remote computing systems through a cloud so a user can store, edit, view, load, save, copy, send to another user, etc., location-based data, location-based metrics, sensor-generated data, metrics based on sensor-generated data, and electronic documents containing location-based data, location-based metrics, sensor-generated data and/or metrics based on sensor-generated data created at device 300.

In some embodiments, device 300 accesses remote computing systems through a cloud so a user can use remotely provided software application services that use location-based data, location-based metrics, sensor-generated data, metrics based on sensor-generated data, electronic documents containing location-based data, location-based metrics, sensor-generated data and/or metrics based on sensor-generated data created at device 300.

FIGS. 6A-6B are flow diagrams illustrating a method 600 of automated population of location-based data and formulae in electronic documents in accordance with some embodiments. The method 600 is performed at a computing device such as a multifunction device (e.g., device 300, FIG. 3, or portable multifunction device 100, FIG. 1A) with a display and a touch-sensitive surface. In some embodiments, the display is a touch screen display and the touch-sensitive surface is on the display. In some embodiments, the display is separate from the touch-sensitive surface. Some operations in method 600 may be combined and/or the order of some operations may be changed.

As described below, the method 600 provides an intuitive way to populate location-based data and formulae in electronic documents. The method reduces the cognitive burden on a user when populating location-based data and formulae in electronic documents, thereby creating a more efficient human-machine interface. For battery-operated computing devices, enabling a user to populate location-based data and formulae in electronic documents faster and more efficiently conserves power and increases the time between battery charges.

The method is performed while the device displays an electronic document at a computing device with a display and one or more user input devices (e.g., electronic document 500 is displayed in FIGS. 5A-5H, and electronic document 530 is displayed in FIGS. 5I-5J). The one or more user input devices may include one or more mice, keyboards, pen and stylus input, finger contacts on a touch sensitive surface or a touch screen display, etc. (e.g., FIG. 2 touch screen 112, stylus 203, FIG. 3 touchpad 355, keyboard/mouse 340, etc., or any suitable input modality).

In some embodiments, the electronic document is a spreadsheet (602) (e.g. FIG. 5A electronic document 530).

In some embodiments, the one or more user input devices include a touch-screen display (604) (e.g., FIG. 5A touch screen 112).

The device detects (606) activation of a first data population control, (e.g., a button, such as first data population control 504 in FIG. 5A).

In response to detecting activation of the first data population control, the device populates (608) in the electronic document first location-based data that includes data obtained from a location-data source (e.g., in response to detecting activation 512 of first data population control 504 in FIG. 5A, the device populates data row 508-1 with latitude, longitude, and place name data derived from a location-data source such as GPS module 136 illustrated in FIG. 1A).

Location-based data may include any number of metrics, some of which may be calculated based on storing and processing a plurality of location-based data readings from the location-data source. Location-based data may include latitude, longitude, elevation above sea level, elevation above the ground at the current location, current and/or average ground speed, current and/or average air speed, relative elevation differences between two locations, great circle distance between two locations, distance between two locations using a user-selected and/or a user-defined map route, distance between two locations using the actual route traveled, etc.

In some embodiments, the location-data source includes one or more sources selected from the group consisting of a GPS receiver, a cellular telephone transceiver, and a WiFi network transceiver (610). For example, the device may receive information from GPS, nearby WiFi base stations, and/or nearby cell towers, as described in U.S. patent application Ser. Nos. 12/040, 283, “Location Determination,” filed Feb. 29, 2008; 12/103,330, “Location Determination Using Formula,” filed Apr. 15, 2008; and 12/122,339, “Location Determination,” filed May 16, 2008. All of these applications are incorporated by reference herein in their entirety.

Further, in some embodiments, the location-data source may be other application programs that can provide location-based data and/or location-based metrics, including without limitation, a compass application program. In some embodiments, the data populated in the electronic document is location-independent, e.g., data corresponding to magnetic north from magnetometer 169 may be populated in the electronic document, and as such, no calculations need be performed before population.

After the first location-based data is populated in the electronic document, the device detects (612) activation of a second data population control (e.g., FIG. 5D activation 518 of second data population control 506-1).

In some embodiments, the first and second data population controls are within the electronic document (614) (e.g., FIG. 5D where electronic document 500 includes first population data control 504 and second data population controls 506-1, 506-2, and 506-3).

In response to detecting activation of the second data population control, the device populates (616) in the electronic document one or more formulae and second location-based data, wherein: the one or more formulae are adapted for performing one or more calculations using the first and second location-based data, and, the second location-based data includes data obtained from the location-data source (e.g., in response to detecting activation 518 of second data population control 506-1 in FIG. 5D, FIG. 5E depicts that data row 508-1 is expanded to include one or more formulae and second location-based data, specifically the location-based metric of distance between Cupertino and Pittsburgh, as well as the latitude and longitude of Pittsburgh.

In some embodiments, the first and second location-based data includes latitude and longitude data (618) (e.g., in FIG. 5E, data row 508-1 includes latitude and longitude data in columns 510-B and 510-C, respectively. Latitude and longitude data for Cupertino in data row 508-1 was populated by activation 512 of first population data control 504 in FIG. 5A, while latitude and longitude data for Cupertino in data row 508-1 was populated by activation 518 of second data population control 506-1 in FIG. 5D). The device calculates (620) one or more location-based metrics using the one or more formulae with at least one of the first and second location-based data (e.g., in FIG. 5E, data row 508-2 includes at least a formula to calculate a location-based metric, distance, between the current location and the location corresponding to the first location-based data, i.e., Waypoint 2, Big Spring).

In some embodiments, the one or more location-based metrics include a calculated distance corresponding to the distance between the first and second physical locations (622) (e.g., in FIG. 5E, data row 508-2 includes at least a formula to calculate a location-based metric, distance, between the current location and the location corresponding to the first location-based data, i.e., Waypoint 2, Big Spring).

The device displays (624) in the electronic document the one or more calculated location-based metrics (e.g., FIG. 5F depicts the calculated location-based metric, distance, between Waypoint 2, Big Spring, and location Pittsburgh).

In some embodiments, the device detects a succession of activations of the first data population control; in response to detecting the succession of activations of the first data population control, the device populates a series of waypoint records in the electronic document, wherein: respective waypoint records correspond to respective activations of the first data population control, and respective waypoint records include data obtained from the location-data source that corresponds to a current location at the time of the respective activation of the first data population control (626) (e.g., activation 512 in FIG. 5A, activation 514 in FIG. 5B, and activation 516 in FIG. 5C depict a succession of activations of the first data population control 504, and the data rows 508-1, 508-2, and 508-3 are populated with respective waypoint records that include location-based data obtained from the location-data source, wherein respective waypoint records include data obtained from the location-data source that corresponds to a current location at the time of the respective activation of the first data population control, i.e., data row 508-1 has location-based data corresponding to Cupertino, which is indicated as the current location 502 of the device at the time of activation 512 of the first data population control in FIG. 5A, data row 508-2 has location-based data corresponding to Big Spring, which is indicated as the current location 502 of the device at the time of activation 514 of the first data population control in FIG. 5B, and data row 508-3 has location-based data corresponding to Pittsburgh, which is indicated as the current location 502 of the device at the time of activation 516 of the first data population control in FIG. 5C).

In some embodiments, the device detects a second activation of the second data population control; in response to detecting the second activation of the second data population control, updating in the electronic document at least the second location-based data with a current location at the time of the second activation of the second data population control (628) (e.g., in FIG. 5G, the second data population control 506-1 is activated 524, and in FIG. 5H, the current location at the time of activation 524, i.e., New York, is used to update the second location-based data in data row 508-1).

FIG. 6C is a flow diagram illustrating a method 650 of automated population of location-based data and formulae in electronic documents in accordance with some embodiments. The method 650 is performed at a multifunction device (e.g., device 300, FIG. 3, or portable multifunction device 100, FIG. 1) with a display and a touch-sensitive surface. In some embodiments, the display is a touch screen display and the touch-sensitive surface is on the display. In some embodiments, the display is separate from the touch-sensitive surface.

Some operations in method 650 may be combined and/or the order of some operations may be changed. Additionally, operations in method 650 may be combined with some operations in method 600 and/or the order of some combined operations may be changed.

As described below, the method 650 provides an intuitive way to automated population of location-based data and formulae in electronic documents. The method reduces the cognitive burden on a user when manipulating user interface objects, thereby creating a more efficient human-machine interface. For battery-operated computing devices, enabling a user to manipulate user interface objects faster and more efficiently conserves power and increases the time between battery charges.

The method 650 is performed at a computing device with a display and one or more user input devices adapted to detect user gestures (e.g., FIG. 5A portable multifunction device 100, FIG. 3 device 300). The device displays an electronic document (e.g., electronic document 550), which in some embodiments, is a spreadsheet (652).

While the device displays the electronic document, the device populates (654) in the electronic document one or more formulae and first location-based data that includes data obtained from a location-data source, wherein the one or more formulae are adapted for performing one or more calculations using location-based data, and the first location-based data corresponds to a first physical location (e.g., FIG. 5K place name, latitude, longitude, bearing, and altitude information corresponding to the location and bearing of the device 300, i.e., Cupertino, are populated in the location column 555-A, latitude column 555-B, longitude column 555-C, bearing column 555-D, and altitude column 555-E, respectively).

The device calculates (656) one or more location-based metrics using the one or more formulae with at least the first location-based data (e.g., FIG. 5K, calculated location-based metrics, such as bearing displayed in 555-D, are calculated using the first location-based data, which corresponds to Cupertino, the first physical location).

In some embodiments, calculated location-based metrics are provided as pre-calculated values for population in the electronic document, e.g., a compass application program may provide a pre-calculated bearing metric for population in the electronic document. Accordingly, in some embodiments, the electronic document need not perform calculations to populate certain location-based data and/or location-based metrics. In some embodiments, the data populated in the electronic document is location-independent, e.g., data corresponding to magnetic north from magnetometer 169 may be populated in the electronic document, and as such, no calculations need be performed before population.

In some embodiments, the one or more location-based metrics are selected from the group consisting of latitude, longitude, bearing, and altitude (658) (e.g., FIG. 5K, location column 555-A, latitude column 555-B, longitude column 555-C, bearing column 555-D, and altitude column 555-E).

The device displays (660) in the electronic document the one or more calculated location-based metrics (e.g., FIG. 5K, calculated location-based metrics, such as bearing displayed in 555-D, are displayed using the first location-based data, which corresponds to Cupertino, the first physical location).

In some embodiments, the device determines a current physical location, and when the current physical location is different from the first physical location, the device updates at least the first location-based data with current location-based data obtained from the location-data source. The device then recalculates the one or more location-based metrics using the one or more formulae with at least the current location-based data, and the device displays in the electronic document the one or more recalculated location-based metrics (662) (e.g., FIG. 5L, device 300 determines its current physical location, Big Spring, is different from the first physical location of Cupertino as illustrated in FIG. 5K; device 300 updates the location-based data corresponding to Cupertino with current location-based data obtained from the location-data source, specifically, data corresponding to Big Spring; device 300 then recalculates and displays updated location-based metrics, such as bearing displayed in 555-D, using the current location-based data).

In some embodiments, determination of the current physical location is performed in response to detecting expiration of a timer (664). In some embodiments, determination of the current physical location is performed in response to detecting arrival at a predefined physical location (666). In some embodiments, the predefined physical location corresponds to an end-point of a mapped route (668).

The steps in the information processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware (e.g., as described above with respect to FIGS. 1A, 1B and 3) are all included within the scope of protection of the invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
while displaying an electronic document at a computing device with a display and one or more user input devices:
detecting activation of a first data population control;
in response to detecting activation of the first data population control, populating in the electronic document first location-based data that includes data obtained from a location-data source;
after the first location-based data is populated in the electronic document, detecting activation of a second data population control;
in response to detecting activation of the second data population control, populating in the electronic document one or more formulae and second location-based data, wherein:
the one or more formulae are adapted for performing one or more calculations using the first and second location-based data, and,
the second location-based data includes data obtained from the location-data source;
calculating one or more location-based metrics using the one or more formulae with at least one of the first and second location-based data; and
displaying in the electronic document the one or more calculated location-based metrics.

2. The method of claim 1, wherein the first and second data population controls are within the electronic document.

3. The method of claim 1, wherein the first and second location-based data includes latitude and longitude data.

4. The method of claim 1, wherein the one or more location-based metrics include a calculated distance corresponding to the distance between the first and second physical locations.

5. The method of claim 1, wherein the location-data source includes one or more sources selected from the group consisting of a GPS receiver, a cellular telephone transceiver, and a WiFi network transceiver.

6. The method of claim 1, wherein the electronic document is a spreadsheet.

7. The method of claim 1, wherein the one or more user input devices include a touch-screen display.

8. The method of claim 1, further comprising:
detecting a succession of activations of the first data population control;
in response to detecting the succession of activations of the first data population control, populating a series of waypoint records in the electronic document, wherein:
respective waypoint records correspond to respective activations of the first data population control, and
respective waypoint records include data obtained from the location-data source that corresponds to a current location at the time of the respective activation of the first data population control.

9. The method of claim 1, further comprising:
detecting a second activation of the second data population control;
in response to detecting the second activation of the second data population control, updating in the electronic document at least the second location-based data with a current location at the time of the second activation of the second data population control.

10. A computing device, comprising:
a display;
one or more user input devices;
one or more processors;
memory; and,
one or more programs, wherein the one or more programs are stored in the memory and configured to be executed by the one or more processors, the one or more programs including instructions for:
while displaying an electronic document on the display at the computing device:
detecting activation of a first data population control;
in response to detecting activation of the first data population control, populating in the electronic document first location-based data that includes data obtained from a location-data source;
after the first location-based data is populated in the electronic document, detecting activation of a second data population control;
in response to detecting activation of the second data population control, populating in the electronic document one or more formulae and second location-based data, wherein:
the one or more formulae are adapted for performing one or more calculations using the first and second location-based data, and,
the second location-based data includes data obtained from the location-data source;
calculating one or more location-based metrics using the one or more formulae with at least one of the first and second location-based data; and,
displaying in the electronic document the one or more calculated location-based metrics.

11. The computing device of claim 10, wherein the first and second data population controls are within the electronic document.

12. The computing device of claim 10, wherein the first and second location-based data includes latitude and longitude data.

13. The computing device of claim 10, wherein the one or more location-based metrics include a calculated distance corresponding to the distance between the first and second physical locations.

14. The computing device of claim 10, wherein the location-data source includes one or more sources selected from the group consisting of a GPS receiver, a cellular telephone transceiver, and a WiFi network transceiver.

15. The computing device of claim 10, further comprising:
detecting a succession of activations of the first data population control;
in response to detecting the succession of activations of the first data population control, populating a series of waypoint records in the electronic document, wherein:
respective waypoint records correspond to respective activations of the first data population control, and
respective waypoint records include data obtained from the location-data source that corresponds to a current location at the time of the respective activation of the first data population control.

16. The computing device of claim 10, further comprising:
detecting a second activation of the second data population control;
in response to detecting the second activation of the second data population control, updating in the electronic document at least the second location-based data with a current location at the time of the second activation of the second data population control.

17. A graphical user interface on a computing device with a display, one or more user input devices, a memory, and one or more processors to execute one or more programs stored in the memory, the graphical user interface comprising:
an electronic document with a first data population control and a second data population control, wherein the electronic document is displayed on the display of the computing device;
wherein:
activation of a first data population control is detected;
in response to detecting activation of the first data population control, first location-based data, which includes data obtained from a location-data source, is populated in the electronic document;
after the first location-based data is populated in the electronic document, activation of a second data population control is detected;
in response to detecting activation of the second data population control, one or more formulae and second location-based data is populated in the electronic document, wherein:
the one or more formulae are adapted for performing one or more calculations using the first and second location-based data, and,
the second location-based data includes data obtained from the location-data source;
one or more location-based metrics are calculated using the one or more formulae with at least one of the first and second location-based data; and,
the one or more calculated location-based metrics are displayed in the electronic document.

18. A computer readable storage medium storing one or more programs, the one or more programs comprising instructions, which when executed by a computing device with a display and one or more user input devices, cause the device to:
while displaying an electronic document on the display:
detect activation of a first data population control;
in response to detecting activation of the first data population control, populate in the electronic document first location-based data that includes data obtained from a location-data source;
after the first location-based data is populated in the electronic document, detect activation of a second data population control;
in response to detecting activation of the second data population control, populate in the electronic document one or more formulae and second location-based data, wherein:
the one or more formulae are adapted for performing one or more calculations using the first and second location-based data, and,
the second location-based data includes data obtained from the location-data source;
calculate one or more location-based metrics using the one or more formulae with at least one of the first and second location-based data; and
display in the electronic document the one or more calculated location-based metrics.

19. A method, comprising:
while displaying an electronic document at a computing device with a display and one or more user input devices:
populating in the electronic document one or more formulae and first location-based data that includes data obtained from a location-data source, wherein:
the one or more formulae are adapted for performing one or more calculations using location-based data, and
the first location-based data corresponds to a first physical location;
calculating one or more location-based metrics using the one or more formulae with at least the first location-based data; and
displaying in the electronic document the one or more calculated location-based metrics.

20. The method of claim 19, further comprising:
determining a current physical location;
when the current physical location is different from the first physical location, updating at least the first location-based data with current location-based data obtained from the location-data source;
recalculating the one or more location-based metrics using the one or more formulae with at least the current location-based data; and
displaying in the electronic document the one or more recalculated location-based metrics.

21. The method of claim 20, wherein determination of the current physical location is performed in response to detecting expiration of a timer.

22. The method of claim 20, wherein determination of the current physical location is performed in response to detecting arrival at a predefined physical location.

23. The method of claim 22, wherein the predefined physical location corresponds to an end-point of a mapped route.

24. The method of claim 19, wherein the one or more location-based metrics are selected from the group consisting of latitude, longitude, bearing, and altitude.

25. The method of claim 19, wherein the electronic document is a spreadsheet.
